(19) United States
(12) Patent Application Publication
(10) Pub. No.: US 2026/0346404 A1
(43) Pub. Date: Nov. 5, 2026

(54) Abrasive Element, Abrasive, and Method for Producing the Abrasive Element and/or the Abrasive

(71) Applicant: Robert Bosch GmbH, Stuttgart (DE)

(72) Inventor: Johannes Huber, Allensbach (DE)

(21) Appl. No.: 19/125,543

(22) PCT Filed: Oct. 26, 2023
(86) PCT No.: PCT/EP2023/079874

§ 371 Date: Apr. 29, 2025

(30) Foreign Application Priority Data
Oct. 31, 2022 (DE) 10 2022 211 520.1

(51) Int. Cl. B24D 18/00; B24D 3/28; C09K 3/14

(52) U.S. Cl. CPC B24D 18/0072; B24D 3/28; C09K 3/1436

(57) ABSTRACT

An abrasive of a flexible abrasive disc is for grinding, abrading, or sanding a workpiece. The abrasive includes main abrasive elements and an adhesive element arranged on the main abrasive elements. The adhesive element is configured as a bonding agent and/or an adhesion promoter.

The invention relates to an abrasive element, an abrasive, and/or a method for producing the abrasive element or the abrasive according to the preamble of claim 1.

### PRIOR ART

Abrasive elements, abrasives, and corresponding producing methods are already known from the prior art.

### DISCLOSURE OF THE INVENTION

The problem addressed by the invention is to improve an abrasive element, an abrasive, and/or a producing method for the latter by means of simple design measures.

The problem is solved with an abrasive element for an abrasive, in particular a flexible abrasive, preferably an abrasive disc, for abrading a workpiece with a main abrasive element.

It is proposed that the abrasive element comprise an adhesive element, which is arranged on the main abrasive element and is configured in particular as an adhesion promoter.

### Adhesive Element

The adhesive element can be configured as an adhesion promoter. For example, the adhesion promoter can strengthen an adhesion between two elements that adhere less well to one another. The adhesion promoter can be arranged between the two elements. In the present example, the adhesion promoter can increase an adhesion of the main abrasive element to a binder element, for example a base binder element and/or a cover binder element. Accordingly, the adhesive element can represent an adhesion promoter for better connection of the main abrasive element to the binder, in particular the base binder element and/or a cover binder element, of the abrasive. The adhesion promoter can in particular be an element that provides a physical and/or chemical bond in an adjacent region of less connectable or unconnectable elements in order to improve an adhesion of these elements.

The adhesive element can be configured as a coating. The adhesive element can surround the main abrasive element, in particular completely. The adhesive element can be arranged in sections on the main abrasive element.

### Base Abrasive Element

The main abrasive element can be provided for abrading a workpiece. The main abrasive element can have a deforming and/or stripping effect on a workpiece to be machined. The main abrasive element can be configured as an abrading body. The main abrasive element is known to a person skilled in the art as an abrasive grain, among other things. In this context, a “main abrasive element” is to be understood in particular to mean an element that contacts a workpiece to be machined in a machining state, in particular directly, resulting in an abrasive material stripping of the workpiece to be machined during a machining state.

The main abrasive element can be configured as a broken or a shaped main abrasive element. The differences are known to those skilled in the art. In particular, when using broken main abrasive elements, it cannot typically be ensured that the main abrasive element has approximately the same dimensions, in particular longitudinal extensions. The main abrasive elements can thus extend differently on the abrasive and lead to a non-uniform abrading pattern or stripping. Due to the uneven longitudinal extension and/or the shape of the main abrasive elements, the main abrasive element can tend to grain break-out, wherein the main abrasive element breaks out of a bond to the abrasive. As a result, an abrasive element with, for example, one or more planar surfaces and/or generally block-shaped, in particular due to a low chemical bond, can lead to break-out from the abrasive.

The main abrasive element is not limited to specific main abrasive elements. For example, the main abrasive element can be corundum (in various forms, in particular white corundum, semi-electrical corundum, blue corundum, zirconia ceramic corundum, and/or brown corundum), silicon carbide, cubic boron nitride, diamond, or mixtures thereof.

As a result, a particularly solid connection of the abrasive element to an abrasive can be achieved.

It can be expedient for the abrasive element to comprise a support element arranged on the main abrasive element for supporting the main abrasive element. The support element can be configured as a filling element. The support element can be configured as a support grain. It is to be understood that a singular number or a plurality of support elements can be arranged on the main abrasive element. In particular, the support elements can be distributed, in particular evenly, over the outer side, in particular the entire outer side, in particular the exterior or surface, of the main abrasive element. The support element can be arranged directly or indirectly on the main abrasive element and in particular can contact the main abrasive element. For example, the support element can be formed from white corundum, zirconia corundum, or the like. The support element can be formed from the same material or material composition as the abrasive element. The support element can be smaller than the abrasive element. The support element can be formed from a broken grain. The support element can be formed from residues of abrasive elements. Residues of the abrasive element can be used, which, for example, are not suitable for use as an abrasive element due to the size, shape, and the like, for example, waste from the producing of a broken abrasive element. As a result, a particularly reliable support effect can be achieved.

It can be expedient for the adhesive element to be configured as a coating surrounding the main abrasive element. The adhesive element can completely surround the main abrasive element, in particular. The adhesive element can surround the support element, in particular entirely. The adhesive element can be configured as a connecting element between the main abrasive element and the binder element, in particular the base binder element and/or the cover binder element, of the abrasive.

It can be expedient for the adhesive element to surround the main abrasive element and/or the support element, in particular completely. The adhesive element can be arranged between the main abrasive element and the support element. The adhesive element can completely surround the main abrasive element and the support element. As a result, a particularly solid connection can be provided.

It can be expedient for the adhesive element to hold a plurality of support elements to the main abrasive element. The support elements can be arranged on an exterior of the main abrasive element. The support elements can be distributed over the entire exterior of the main abrasive element. Alternatively, the support elements can be arranged in sections on the main abrasive element, for example in a section which is not intended for the machining of a workpiece. The support elements can be arranged substantially spaced apart from each other. The support elements can be enveloped by the adhesive element. The support elements can be arranged on the main abrasive element and/or in particular surrounded by the adhesive element such that a plurality of uneven surfaces of the abrasive element result. As a result, an anchoring of the abrasive element to the abrasive can be increased.

It can be expedient for the main abrasive element to be formed from a natural and/or synthetic diamond. The main abrasive element can also be formed from other carbon modifications that appear to be useful to a person skilled in the art, which are suitable for the purpose of a main abrasive element. It is understood that the main abrasive element can also be formed from other materials that appear to be useful to a person skilled in the art. In principle, the main abrasive element can be formed from a mineral and/or ceramic material, for example from corundum, silicon carbide, boron nitride, or the like. For example, the main abrasive element can be realized by aluminum oxide particles having a particle size of between 7 μm and 300 μm. The main abrasive element can have any geometric configuration that appears sensible to a person skilled in the art. The main abrasive element can be a so-called shaped main abrasive element or a broken main abrasive element. A main abrasive element causes friction and temperature development on the object to be machined, which imparts a deforming and/or stripping effect on or into the object to be machined.

The main abrasive element, which is formed in particular from a diamond, can exhibit a low chemical bond to the phenolic resin due to a typically block-like shape or surface and a plurality of flat faces (no textured faces), which may lead to cracks in the abrasive or between the main abrasive element and phenolic resin. Small gaps between the main abrasive element and the binder element can quickly lead to a break-out of the abrasive element from the abrasive due to the lack of textured surfaces.

It can be expedient for the adhesive element to be formed from a polyurethane, in particular a bicomponent polyurethane. This achieves good adhesion to, for example, a diamond surface, in particular a better adhesion, as on the abrasive element coated with phenolic resin. In particular, a poor chemical bonding of the main abrasive element with the binder element (base binder element, cover binder element) of an abrasive can thereby be balanced or improved by the adhesive element. The adhesive element can serve as an adhesion promoter between the main abrasive element formed from diamond and the binder element of the abrasive formed from phenolic resin. Due to its tough elastic properties, the adhesive element can in particular absorb shocks, whereby a break-out of abrasive elements can be prevented or reduced. The main abrasive element can thus be better held on the abrasive.

It can further be expedient that one, in particular each, extension of the main abrasive element is greater by at least 100%, in particular at least 200%, preferably at least 250%, preferably at least 300%, and particularly preferably at least 350% compared to one, in particular each, extension of the support element. One, in particular each, volume of the main abrasive element can be greater than one, in particular each, volume of the support element by at least 100%, in particular at least 200%, preferably at least 250%, preferably at least 300%, and particularly preferably at least 350%.

Because it cannot be ensured that each main abrasive element or each support element falls under the limitation(s) described above, due to the plurality of in particular broken main abrasive elements and/or each individual support element, an extension is understood here to mean a plurality of elements, in particular, and a volume is understood to mean an average volume of a plurality of elements. As a result, a particularly reliable support effect can be achieved.

It can be expedient for the average size of the support elements to be less than the average size of the abrasive element and the main abrasive element, respectively. As a result, the support elements can equally cover the surfaces of the main abrasive element as well as the interstices between them. The ratio of the average diameter of the main abrasive elements to the average diameter of the main abrasive elements can be less than 10, in particular less than 5, preferably less than 3, and further preferably less than 2.

The support element can be arranged directly or indirectly on the main abrasive element. The support element can be arranged adjacent to the main abrasive element. The support element can be provided so as to support the main abrasive element in a usage state. The support element can be provided so as to increase a firmness, a heat resistance, and a toughness of the abrasive. The support element can be provided for admixing with the main abrasive element. The support element can be arranged between two main abrasive elements. The support element can be provided so as to increase a surface or exterior of the main abrasive element in order to prevent a break-out of the main abrasive element. The support element can be provided so as to reduce or prevent a deflection of the main abrasive element, in particular in a usage state, in order to achieve a better abrading effect. The support element can have a high mechanical strength. The support element can be provided as an admixture with the main abrasive element.

The invention further relates to an abrasive, in particular a flexible abrasive, preferably an abrasive disc, for abrading a workpiece with an abrasive element.

The abrasive can have a longitudinal extension or—in the case of a disc—a diameter of up to 500 mm, in particular up to 400 mm, preferably up to 300 mm, preferably up to 200 mm, more preferably up to 170 mm, such as 150 mm or even less.

The abrasive can have a thickness of up to 5 mm, in particular up to 3 mm, preferably up to 2 mm, preferably up to 1 mm, particularly preferably up to 0.5 mm, such as 0.4 mm or even less.

In order to compensate for local imperfections and to provide an optimum ground surface, the abrasive can be flexible. “Flexible” is understood to mean, in particular, formed from or containing a pliable material.

It can be expedient for the abrasive to comprise a carrier element, being in particular flexible, for the assembly of the abrasive element, in particular by means of a binder element.

The abrasive material can be in particular suitable for hard and abrasive workpieces, for example concrete floors. In this respect, the abrasive element can be largely integrated or embedded in the binder element, in particular the cover binder element, during the manufacture of the abrasive. The binder element can wear down during the machining operation in order to expose the main abrasive elements. Further wear of the binder element, in particular the cover binder element, can be prevented by the exposed main abrasive elements. During such a “abrading-in operation,” support elements located on the exposed surface of the main abrasive element can also be stripped away, while the further support elements located on the side facing away from the workpiece are not affected.

The abrasive can comprise a plurality of abrasive elements on one side, in particular a surface, of the carrier element. The abrasive elements can protrude from the carrier element and/or can limit the abrasive.

The abrasive is used for abrading or abrasive machining of a workpiece during which material of the workpiece is mechanically stripped from the surface of the workpiece in the form of chips. The abrasive can be a coated abrasive or a composite abrasive comprising foam and an upper material or a foam abrasive. In principle, alternative abrasive are also contemplated, for example bonded abrasives, which are typically resin-bonded cutting and roughing discs. The abrasive can be configured as an abrading paper. The abrasive can be coated (“coated abrasive”) or uncoated.

The abrasive can be present in different assembly forms, for example as an abrasive disc or as an abrading belt, as a sheet, roll, strip or as a web of abrading items (e.g. in producing). In particular, the abrading item can be produced for use with abrading machines, such as eccentric abrading machines or also by hand polishing. For example, the abrading item can be realized as a hand polishing sheet, an abrading belt, or an abrasive disc covered with velours.

The binder element can comprise a base binder element and/or a cover binder element. The base binder element can be provided so as to cover the carrier element and/or the abrasive element. The cover binder element can be provided so as to cover the carrier element, the base binder element, and/or the abrasive element. The base binder element and/or the cover binder element can be configured as layers on the carrier element.

In this context, a “base and/or cover binder element” is understood in particular to mean a material or material mixture that is arranged in an in particular laminarly expanded manner, which is arranged in the normal direction of a main extension surface of a carrier element of the abrasive, in particular directly, between a surface of the carrier element of the abrasive and the abrasive element(s). The base and/or cover binder element can be provided for a material-locking connection of the abrasive element(s) and the carrier element of the abrasive. As a result, a preferably good and reliable adhesion and a material-locking connection of the base and/or cover binder element on the at least one surface of the at least one base body of the abrading unit can be achieved.

The carrier element of the abrasive can comprise any substrate, in particular a flexible substrate, that is common in the abrasive industry. For example, the carrier element can be formed from a textile, fabric, stitch-bonded fabric, knit fabric, braiding, paper, cardboard, foil, volcanic fiber, etc., or a combination thereof. The carrier element can be formed from one or more layers. The carrier element can preferably be formed at least from a paper material and/or from a tissue material and/or from a foil material. In this context, a “paper” is understood in particular as a material that is at least partially made of fibers, in particular plant fibers, preferably at least partially by matting and gluing, and at least partially pressed into a layer, in particular one that is thin and smooth. In this context, a “fabric material” is understood in particular to mean a material that is at least partially woven and consists of intersecting fibers, in particular threads. In this context, a “foil material” is understood in particular to mean a material that consists at least in part of at least one metal, at least one metal alloy, and/or at least one plastic and that is at least partially produced in webs which are in particular very thin.

The carrier element can serve as the carrier layer, and gives the abrasive specific properties in terms of adhesion, elongation, resistance to tearing and pulling, flexibility, and stability. The abrasive elements can be applied and fixed onto the support layer. The abrasive elements can be arranged and/or bonded to the carrier element by means of a base binder element, which is known per se. For example, in a coated abrasive, abrasive elements adhere to the carrier element due to the base binder element. By means of the base binder element, the abrasive grains can be pre-fixed in the desired position and distribution on the carrier element. Suitable base binder elements for attaching abrasive elements to the carrier element from the prior art are well known to the person skilled in the art.

The abrasive can contain one or more cover binder elements, in particular layers of cover binder elements. In the case of two layers of cover binder elements, the lower cover binder element is commonly referred to as “cover binder 1” or “size coat” and the upper cover binder element as “cover binder 2” or “supersize coat.” The topmost cover binder element can be uncured, i.e. the cover binder element forming the outermost layer and facing away from the carrier element of the abrasive. The cover binder elements can be applied in particular layer by layer onto the base binder element and the abrasive elements. The cover binder element securely connects the abrasive elements to one another and to the carrier element. The abrasive can comprise a first side, in particular a holding side, and a second side, in particular an abrading side, facing away from the first side. The abrasive can be limited on the holding side by a holding face. The abrasive can be limited on the abrading side by an abrading face.

The holding side can comprise a fastening means. The fastening means can be provided for an assembly of the abrasive on a machine tool, in particular an abrading plate of a machine tool. The fastening means can comprise a mechanical connecting element, for example a hook and abrading fastener element, a screw fastener element or a clamp locking element. The fastening means can comprise an adhesive connecting element, such as an adhesive locking element.

It can be expedient for the base binder element and/or the cover binder element to be formed from a resin, in particular a phenolic resin. Resins such as phenolic resin, epoxy resin, urea, melamine resin, polyester resin, or the like are contemplated in particular as a base binder element and/or a cover binder element. The base binder element and the cover binder element can also contain other common active ingredients and/or fillers.

The invention further relates to a method for producing a/the abrasive element for an in particular flexible abrasive comprising the steps of:
providing a main abrasive element;
providing a support element;
material-locking connection of the support element and the main abrasive element, in particular by means of an adhesive element.

The main abrasive elements and the support elements can be provided in a suitable number and quantity. The main abrasive elements and the support elements can be provided as a bulk material. The adhesive element, which produces in particular the material-locking connection, can be present in liquid form, in viscous form, or in pasty form, or the like.

A mixing apparatus can be used in order to produce a material-locking connection of the support element and the main abrasive element. Suitable mixing apparatuses are known to those skilled in the art.

The mixing apparatus can comprise a receiving unit for receiving the mixture, in particular the main abrasive element, the support element, and the adhesive element. The receiving unit can be present in a receiving state in which the receiving unit is open for receiving mixture. The receiving unit can be present in a closing state in which the receiving unit ejects the mixture and in particular avoids or prevents an unwanted leakage of the mixture from the receiving unit. The receiving unit can be configured as a receiving drum.

The mixing apparatus can comprise a mixing unit for mixing the mixture. The mixing unit can comprise a mixing element. The mixing element can be configured as a screw mixer, a paddle mixer, or the like. The mixing element can be arranged, in particular entirely, in the receiving unit. The mixing element can be supported movably or immovably in relation to the receiving unit. The mixing element can contact the mixture directly or indirectly.

The mixing apparatus can comprise a driving unit. The driving unit can drive the receiving unit and/or the mixing unit, in particular the mixing element, and move them relative to each other.

The mixing unit can transfer an appropriate mixing movement of the receiving unit and/or the mixing unit to the mixture in order to mix the mixture. It is understood that other mixing principles regarded as advantageous by a person skilled in the art can also be used.

The coating of the abrasive elements with the support elements is carried out at room temperature by mixing the abrasive element with the support element and the adhesive element to be used. The adhesive element, in particular along with the support element, can be distributed over the abrasive element due to the surface tension, in particular relatively homogeneously.

For example, the abrasive element can be formed from, in particular 30 g diamond, in particular 6 g white corundum, in particular 1.5 g glue element (Huntsmann ABR8910). For example, the abrasive element can be formed from in particular 30 g diamond, in particular 4 g white corundum, in particular 1 g glue element (Huntsmann ABR8910).

In a further step, the mixture can be cured by means of a curing unit. Suitable curing principles and curing units are known to those skilled in the art. The mixture can occur during the mixing process or subsequent to the mixing process.

After the mixing operation of the mixture, the mixture can be cured in a heating unit, in particular in an oven unit, at a temperature of more than 50 °C, in particular at more than 100 °C, preferably at more than 130 °C, for example at 140 °C. Typically, the mixture can be cured for more than 5 min, in particular for more than 8 min, for example for 10 min, by means of the heating unit. The main abrasive elements coated with the adhesive element can be glued to further main abrasive elements.

In a further step, in particular during or after curing, an electrically conductive material can be applied to the coated main abrasive element or the abrasive elements. The electrically conductive material can be configured as an organic compound. In particular, the organic compound can be configured as at least one ionic liquid and/or conductive polymer. It is conceivable that the organic compound is either applied in a pure form to the abrasive grain and/or as a solution dissolved in a solvent, for example in water, on the abrasive grain. Such an organic compound for an abrasive element (hereinafter “abrasive grain”) is disclosed in patent application DE102017204605A1. In this regard, reference is made to the application DE102017204605A1, the contents of which are hereby incorporated in this application. The tendency of the coated main abrasive elements or the abrasive elements to crack can thereby be increased.

During or after curing, the abrasive elements can be individually linked, due in particular to the adhesive element. In a further step, the related abrasive elements can be broken and separated by means of a separating unit, in particular with low force. The separating unit can comprise a separating element for separating the glued mixture. The separating element can be configured as a separating ball. The separation ball can apply an in particular light mechanical force to the mixture in order to remove the glued main abrasive elements or to break or separate abrasive elements from one another.

For example, the separating element can be attached to the receiving unit after the curing step in order to be able to perform the separating operation.

In order to simplify the separation process of the coated main abrasive elements or the abrasive elements, the mixture can be rotated in the heating unit, in particular the oven unit, during the curing process, for example in the (further) receiving unit, configured in particular as a receiving drum. As a result, a gluing of the mixture or the coated main abrasive elements or the abrasive elements could be reduced or prevented.

In a further step, the non-separated abrasive elements can be separated from the individual abrasive elements by means of a sieve unit. The non-separated abrasive elements (boiling residue) can be fed to the separating unit.

The invention further relates to an abrasive, in particular a flexible abrasive, preferably an abrasive disc, for abrading a workpiece with a carrier element, in particular a flexible carrier element, for assembling an abrasive element.

It is proposed that the abrasive comprise a through-hole for receiving an abrasive element.

The through-hole can extend through the entire carrier element. The through-hole can extend from one side of the carrier element to a side of the carrier element facing away from the one side.

The through-hole can be provided for receiving an abrasive element. The through-hole can be configured as a receiving opening for receiving an abrasive element. The through-hole can limit an assembly of an abrasive element on the abrasive. The through-hole can be aligned in the abrasive elements. The through-hole can laterally support the abrasive element. The through-hole can be configured such that the abrasive element is indirectly or directly held in the through-hole.

As a result, the abrasive element can be more strongly bonded to the separating element, which can reduce or prevent break-out of abrasive elements (grain break-out). In particular, the abrasive element can be arranged “deeper” in a binder element, and in particular can be surrounded by it. In particular, a thinner layer of a binder element can thereby be achieved. As a result, the abrasive can be more flexible.

It is understood that a singular number or a plurality of through-holes can be provided. The through-holes can be arranged at a distance of at least 1 mm, in particular at least 2 mm, in relation to each other. The, in particular each, through-hole can have a hole diameter of at least 0.1, in particular at least 0.3 mm, preferably at least 0.5 mm.

The carrier element can have a material thickness of at least 1 mm, in particular at least 2 mm, preferably at least 5 mm.

The hole diameter of the through-hole and the material thickness of the carrier element can be adapted to the abrasive element, in particular a size of the abrasive element (grain). As a result, a desired quantity of abrasive elements (grain amount) can be applied. Thus, the amount of abrasive elements can be very constant and can occur independently of a duration of a scattering operation of abrasive elements.

The through-hole can be introduced into the carrier element by means of a stamping method, a laser method, a piercing method (for example, a needle roll), or the like.

When piercing, in particular by means of a piercing process, a beading can be formed in the carrier element. The beading can surround the through-hole. The beading can be arranged on the rear side or on the holding side of the abrasive or carrier element 31. The beading can be configured as an elevation arranged around the through-hole and/or limiting the through-hole. The beading can form a depression associated with the beading on an abrading side. The beading, in particular the depression of the beading, can optimally align the abrasive elements. By means of the beading, the abrasive element arranged in the through-hole can be particularly advantageously aligned.

It can be expedient for the abrasive to comprise a base binder element for an assembly of the abrasive element on the carrier element, in particular in the through-hole of the carrier element. The base binder element can be provided for holding the abrasive element in the through-hole. The base binder element can fix the abrasive element in the through-hole. This can prevent a break-out of the abrasive element (grain break-out).

It can be expedient for the base binder element to be arranged in the through-hole. The base binder element can fill the through-hole, in particular completely. The base binder element can limit the through-hole. The base binder element can limit an extension of the through-hole through the carrier element. The base binder element can be arranged in the region of a side of the carrier element facing away from the abrading side. As a result, an abrasive element can be particularly advantageously held on the through-hole.

It can be expedient for the base binder element to be arranged on the through-hole. The base binder element can be arranged on a side facing away from the abrading side. The base binder element can limit the through-hole, in particular on a side facing away from the abrading side. The passage element can cover the through-hole, in particular completely. The base binder element can be configured as a foil element, in particular an adhesive foil element, which is arranged on the side of the carrier element facing away from the abrading side. The base binder element can be connected to the carrier element over its full surface.

As a result, a mechanical flexibility can be improved. In particular, more abrasive elements can be involved in the abrading process. Support elements can be omitted due to the abrasive elements arranged in the through-hole. In particular, this is because the abrasive element can be supported by the carrier element limiting the through-hole. In particular, a chipping space for abrading dust can be enlarged, thereby avoiding sensitivity to clogging. In addition, the abrasive element(s) can be better aligned.

It can be expedient for the carrier element to have a coating, in particular an electrically conductive coating, for an orientation of the abrasive element, in particular in an electrostatic field. The coating can be arranged on a side of the carrier element facing away from the abrading side. Such coated carrier elements are available from the company Ahlstrom-Munksjö, for example. As a result, an electrostatic force can have a stronger effect in the breakthrough recess, as in neighboring regions, whereby the abrasive element is preferably pulled towards the breakthrough recess.

It can be expedient for the base binder element to be arranged in a rigid form and/or in the form of a foil on a side of the carrier element facing away from the abrading side.

The invention further relates to a method for producing an in particular flexible abrasive, in particular according to any of the preceding claims, comprising the steps of:
providing a carrier element for assembling an abrasive element on the carrier element, and
providing a through-hole extending in particular through the entire carrier element for receiving the abrasive element.

It can be expedient that, in one step, a base binder element is arranged on a side of the carrier element and/or the through-hole facing away from the abrading side.

The base binder element is not to be applied as usual on the abrading side of the carrier element, but rather on a side facing away from the abrading side of the carrier element or on the holding side of the carrier element.

The base binder element can be applied to the carrier element by means of a squeegeeing method and in or on the through-hole. The base binder element can be applied to the carrier element in a liquid state, in particular in a viscous state, preferably in a pasty state. The base binder element can remain stuck in the through-hole due to the state and the surface tension.

In one step, the base binder element can be applied to the carrier element over its full surface. The base binder element can coat the carrier element over its full surface. A layer or a foil of the base binder element can remain on the carrier element. In a further step, a further layer, for example a velour, a cover paper, or an anti-slip coating, can be applied or laminated onto the base binder element.

As an alternative to the squeegee application of a liquid base binder element by means of a squeegeeing method, the base binder element can be configured as a foil element, in particular an adhesive foil element. The foil element can be arranged on the side of the carrier element facing away from the abrading side and can be arranged or glued on the carrier element. As a result, the carrier element can be substantially “sealed” such that residues from a binder element on a side facing away from the abrading side can be avoided. These residues can soil the producing rollers and make the producing process more difficult. As a result, a curing/drying/deactivation of the base binder element arranged on the side facing away from the abrading side can be omitted. Further, the use of a liquid base binder element can be avoided.

When using a binder element configured as a foil element, a produced abrasive can be rolled up and stored without a protective foil element, for example a wax paper, because the base binder element, for example a self-adhesive, can be held in the through-hole.

In a further alternative embodiment, a hot melt layer can be applied to the rear side of the perforated paper. This can be scattered from the opposite side either directly in a hot state or heated up again with an IR radiator before the scattering process, for example. The layer can also be utilized in order to apply a velour at the same time.

As an alternative to the perforated foil, an open fabric (e.g. 50 g/m²) can be used, onto the rear of which an adhesive foil is applied. The grains then remain stuck in the fabric during the scattering process. The method has the advantage that a “mesh” is incorporated, and the abrasive could therefore be marketed as “mesh abrasive.” Here, an adhesive foil, hot melt application, or liquid spread can also be used as the adhesive layer (Note however, that the advantage of the high end flexibility of the abrasive is lost with this variant).

It can be expedient for the carrier element to be scattered with a plurality of abrasive elements in one step, in particular by means of electrostatics or compressed air.

In one embodiment of the method, the abrasive elements can be electrostatically scattered onto the carrier element. The abrasive elements are electrostatically charged in an external electrical field by electrostatic interaction with this external electrical field and accelerated onto the carrier element.

In the electrostatic scattering operation, those abrasive elements can become stuck in the through-hole, which are aligned during the scattering operation substantially perpendicular to the abrasive, in particular to the abrading face. To the extent that the abrasive element strikes the breakthrough recess substantially perpendicular to the abrasive, it is “suctioned” into the breakthrough recess by the surface tension of the base binder, whereby the abrasive element is raised further in a perpendicular direction.

Abrasive elements that are aligned substantially parallel to the abrasive, in particular to the abrading face, can be dismissed in that the abrasive elements are discharged on the carrier element and fall back. As a result, particularly advantageous bundles of abrasive elements can be created, which are glued by means of the binder element arranged in or behind the breakthrough recess. The curing of the base binder element as well as the application of the cover binder element can occur classically, i.e. thermally, bicomponent, UV, etc. and are known to a person skilled in the art.

The amount of abrasive elements can be determined by the hole diameter of the breakthrough recess and the amount of base binder element arranged on the carrier element.

In a further embodiment of the method, the abrasive elements can be pneumatically scattered onto the carrier element, in particular by means of compressed air. The compressed air flows towards and around the abrasive elements, which are accelerated onto the carrier element. The abrasive elements can thereby be blown into the breakthrough recess by means of compressed air. Alternatively, the base binder element can be omitted, and the abrasive elements can be suctioned into the breakthrough recesses from the holding side of the carrier element. If necessary, jams of abrasive elements (similar to a filter that is deliberately clogged with abrasive grain) can be prevented in a supportive manner with compressed air pulses on the abrading side of the carrier element.

Alternatively or additionally, the abrasive elements can be mechanically or gravimetrically scattered onto the carrier element. “Mechanical scattering” means, in particular, that the abrasive elements are spread onto the carrier element by mechanical acceleration. This can be done, for example, using a rotating centrifugal accelerator, i.e. similar to a rotating disc, in which the abrasive elements are accelerated radially outward. Alternatively or additionally, a gravimetric scattering can be realized using a “slide.” “Gravimetric scattering” means that the abrasive elements are scattered onto the carrier element under the influence of gravity.

In one embodiment of the method, the sieve is realized in metal and operates as a high-voltage electrode during an electrostatic scattering. A counter-electrode for electrostatically scattering the abrasive elements can be arranged behind the carrier element, in particular behind a carrier element product path, or itself realized by the carrier element, in particular by the carrier element material web, provided it is electrically conductive or comprises an electrically conductive (e.g. aqueous or soot-filled) binder element. In this way, a particularly effective electrostatic scattering of the abrasive elements can take place, in which a risk of agglomeration of the, for example, previously de-agglomerated abrasive elements can be largely avoided.

It can be expedient that, in one step, abrasive elements which are not arranged in the through-hole, and/or are held on the carrier element by means of the base binder, are removed.

The invention further relates to an abrasive, in particular a flexible abrasive, preferably an abrasive disc, for abrading a workpiece with a carrier element, in particular a flexible carrier element, for assembling an abrasive element by means of a base binder element.

It is proposed that the abrasive comprises an adhesion limiting element arranged on the carrier element for limiting an assembly of the base binder element on the carrier element.

The adhesion limiting element can reduce or prevent an assembly of the base binder element on the carrier element. The adhesion limiting element can diminish or prevent an assembly of an abrasive element on the carrier element. The adhesion limiting element can be provided so as to displace or discharge a base binder element arranged on the carrier element, in particular so that the adhesion limiting element does not become enmeshed with the base binder element. The adhesion limiting element can be considered a kind of “anti-stick element” or “stick-stop element.” The adhesion limiting element can be partially arranged on the carrier element and can cover a portion of the carrier element. The adhesion limiting element can be arranged indirectly or directly on the carrier element. The adhesion limiting element can extend along an extension, in particular the entire extension, of the abrasive.

It can be expedient for the abrasive to have an abrading region and a free region adjacent to the abrading region. The abrading region can be formed or limited by the free region. It can be advantageous for the abrading region to be formed by a base binder element limiting the abrading region. The, and in particular each, base binder element can form or limit the abrading region. The abrading region can be formed from a plurality of base binder elements, which are in particular spaced apart from one another. The base binder elements can be configured as base binder element points. The base binder elements can be configured in the form of islands, in particular of base binder islands. The base binder elements can have an extension or diameter of less than 3 mm, in particular less than 2 mm, preferably less than 1 mm, for example 0.7 mm. The base binder element can be formed from or consist of a phenolic resin, urea resin, polyurethane resin, polyester resin, optionally also UV-curing, etc. The base binder element can be cured for specific materials or depending upon the base binder element used. The abrading region can be formed from a base binder element and/or from a plurality of base binder elements. The abrading region can be formed from a plurality of spaced apart base binder elements. The base binder elements in the abrading region can be arranged in close proximity to each other or in a group. The base binder elements can receive a plurality of abrasive elements and hold them, in particular bundled, on the support element. As a result, regions or channels, which are free from a base binder element or abrasive elements, are provided in the abrading region between the base binder elements. These regions or channels can be provided for optimum dust transport.

Furthermore, it can be advantageous for the abrading region to be surrounded by the free region. Furthermore, it can be advantageous for the abrading region to surround the free region. In addition, it can be advantageous for the free region to be substantially limited by a plurality of base binder elements, in particular the abrading region. The abrading region and the free region can have different visual characteristics. The free region is configured so as to be free from the, in particular each, base binder element. The abrading region and the free region, in particular their delimitations to one another, can form a contrast. The contrast can form the information pattern. As a result, information can be provided to the user in a particularly straightforward manner.

The adhesion limiting element can be arranged on the, in particular at all, free regions of the carrier element. The adhesion limiting element can form the free regions. The adhesion limiting element can be printed on the carrier element. The base binder element can be applied to the carrier element in particular in a laminar manner, preferably over its full surface, in particular by means of a roller. In particular, the region, in particular the free region, of the carrier element which is not intended to receive a base binder element can be coated using the adhesion limiting element. The base binder element arranged on the adhesion limiting element (free region) can retract to a region, in particular an abrading region, of the carrier element, which is not coated by the adhesion limiting element.

In a scattering operation in which the abrasive element is scattered onto the carrier element, the abrasive element remains adhered to the region of the carrier element on which the base binder element is arranged.

A cover binder element can also be applied to the carrier element, in particular in a laminar manner, preferably over its full surface, and in particular rolled using a roller. In particular, the region, in particular the free region, of the carrier element which is not intended to receive a cover binder element can be coated using the adhesion limiting element. The cover binder element arranged on the adhesion limiting element (free region) can retract to a region, in particular an abrading region, of the carrier element, which is not coated by the adhesion limiting element. The cover binder element can also retract to the abrading regions (with abrasive elements), where the cover binder element is additionally attracted by the capillary forces between the abrasive elements.

In order to detect a used adhesion limiting element, microscopically small (not recognizable with the naked eye) droplets of a binder element, in particular a base binder element, on which the adhesion limiting element, in particular on which no abrasive element, is arranged, can be detected. Alternatively or additionally, a surface tension in the regions of the adhesion limiting element can be measured.

It can be expedient for the adhesion limiting element to have a viscosity that is adapted to the base binder element.

Furthermore, it can be expedient for the abrasive to have an opening, in particular a suction port, for the suction of abrading dust, wherein the suction recess is limited by the adhesion limiting element. The opening can be arranged in the free region. The opening can be spaced apart from the abrading region. The opening can extend through the support element, in particular through the entirety of the abrasive. The opening can be configured as a breakthrough. In this context, an “opening” is to be understood in particular to mean a continuous hole, in particular through the entire material thickness of the abrasive. The opening can be configured as a round hole. However, it is also conceivable for the person skilled in the art to consider other hole shapes to be useful, such as triangles, rectangles, squares, polygons, stars, or combination of these hole shapes. The opening can have a diameter of up to 10 mm, in particular up to 7 mm, preferably up to 5 mm, preferably up to 4 mm, more preferably up to 3 mm, such as 2.4 mm or even less. The opening and the abrading region can limit the free region. The opening can be surrounded by the free region, in particular entirely, preferably in a plane by 360°. The opening can be limited by the free region. This can prevent an abrasive element from being hit or punched or laser-cut during manufacture of an opening by, for example, a stamping process or a laser cutting method, which can minimize wear during manufacture. The opening can have an extension and the free region can have an extension, wherein the, in particular each, extension of the opening is smaller than the, in particular each, extension of the free region. As a result, an opening can be particularly advantageously punched into the free region, provided that the extension of the free region is larger than the opening to be provided.

It can be expedient that the base binder element is formed from more than 40 wt.-%, in particular more than 50 wt.-%, preferably more than 55 wt.-% and/or less than 80 wt.-%, in particular less than 70 wt.-%, preferably less than 65 wt.-%.

A further embodiment of the [invention] comprises a method for producing a, in particular flexible, abrasive comprising the steps of:—providing a carrier element for assembling an abrasive element on the carrier element, and
providing an adhesion limiting element for limiting an assembly of the base binder element on the carrier element.

It can be expedient for the base binder element, in particular by means of a rolling process, to be attached to the carrier element, in particular over its full surface, in one step.

It can be expedient for the carrier element to be scattered with a plurality of abrasive elements in one step, in particular by means of electrostatics or compressed air.

It can be expedient for the cover binder element, in particular by means of a rolling process, to be attached to the carrier element, in particular over its full surface.

The invention further relates to a method for producing an in particular flexible abrasive comprising the steps of:—providing a carrier element for assembling an abrasive element on the carrier element and—providing a pad printing element and/or a silicone roller element for an assembly of a base binder element on the carrier element.

The pad printing element and/or the silicone roller element can be provided for receiving the base binder element. The pad printing element and/or the silicone roller element can be provided for holding the base binder element. The pad pressure element and/or the silicone roller element can be provided for an assembly or a delivery of the base binder element on the carrier element.

The pad printing element and/or the silicone roller element can be formed from a material, in particular an elastic material, in particular a silicone material, preferably a silicone rubber.

The base binder element can be placed on the carrier element using a pad stamping element by means of a pad printing process or using a silicone roller element by means of a silicone rolling process. The pad printing process can be configured as an indirect deep-drawing process.

A transfer of the base binder element to the carrier element can be carried out by pressing at different levels of contact force.

The base binder element can be transferred to the carrier element by pressing the pad pressure element and/or the silicone roller element, in particular by means of a pressing force.

The base binder element applied to the carrier element, in particular by the pad printing method and/or the pad rolling method, can have an edge region where the base binder element drops off flat, which typically indicates the use of such a method.

Due to a flexibility and conformability of the pad printing element and/or the silicone rolling element, the base binder element can also be employed in case of non-planar, in particular complex shaped, surfaces of a carrier element. In particular, different materials to be imprinted can be used so that the carrier element, for example, consisting of a plastic, a rubber, a glass, a ceramic, a paper, a wood, a metal, and many other materials can be coated.

A common alternative in a silicone pad element could be a silicone roll.

In the electrical variant, the roller drive is carried out by means of worm gear motors. Operation occurs via a double-foot button for forward and return in inching mode. To secure the hazardous locations, cable pull switches are located directly in front of the feed locations, the triggering of which results in immediate drive stop and pneumatic opening of the roller nip (>120 mm).

It can be expedient for a printing plate element to be provided in one step for mapping a printing shape, in particular a negative printing shape.

The printing plate element can comprise a printing recess for receiving the base binder element. For example, the printing plate element can be formed from a metal, in particular a steel, or a plastic. The printing plate element can be referred to as a stereotype plate. The printing plate element can be limited by the printing recess. The printing recess can be limited by the printing plate element in a plane by 360°. The printing plate element can be adapted to the carrier element, in particular one adapted to the shape, preferably to the surface, of the carrier element.

The printing recess can be configured on the printing plate element by means of a milling method, for example.

The printing plate element, in particular the printing recess, can form a printing pattern, in particular a negative printing pattern. The printing pattern can be transferred to the carrier element by means of the pad punch element.

It can be expedient that in one step, a squeegee element, in particular a box squeegee element, is provided for assembling the base binder element on the printing plate element, in particular the printing recess of the printing plate element.

The squeegee element can be provided for assembling the base binder element on the printing plate element, in particular in the printing recess. The squeegee element can be provided for receiving the base binder element. The squeegee element can be provided for a stripping of a viscous element, in particular a base binder element.

It can be expedient for the carrier element to be scattered with a plurality of abrasive elements, in particular by means of electrostatics or compressed air. The power supply requires 3×400V/50 Hz supply voltage as well as compressed air (6 bar).

It can be expedient to provide a cover binder element, wherein the cover binder element, in particular by means of a rolling process, is arranged on the carrier element, in particular entirely.

The invention further relates to an abrasive, in particular a flexible abrasive, preferably an abrasive disc, for abrading a workpiece with a carrier element, in particular a flexible carrier element, for assembling an abrasive element by means of a base binder element and with a cover binder element for covering the abrasive element and/or the base binder element.

It can be expedient for the abrasive to have a first depression recess, in particular a first slot recess, which is arranged in the base binder element and/or the cover binder element.

The depression recess can be configured as a kind of target breaking point. The depression recess can limit the cover binder element. The depression recess can limit the base binder element. The depression recess can separate the base binder element and/or the cover binder element from each other. The depression recess can define a bending edge of the abrasive. The depression recess can be limited by the carrier element. The depression can range in comparison to a thickness of the abrasive by at least 20%, in particular by at least 30%, preferably by at least 40%, preferably by at least 50%, particularly preferably by at least 60%, and/or by at most 90%, in particular by at most 80%, preferably by at most 70%, and preferably by at most 60%.

The depression recess can be arranged in particular in a region, in particular in each region, which is free of a, in particular each, abrasive element. In particular, the depression recess can be arranged spaced apart from one, in particular each, abrasive element.

To increase a flexibility of the abrasive, the abrasive is typically deflected. The deflection occurs around a radius, for example by means of a kind of roller, in particular a rubber roller. As a result, at least the cover binder element is deflected such that cracks form in the cover binder element, thereby achieving increased flexibility of the entire abrasive. These cracks are commonly referred to as flex cracks. However, such flex cracks are disadvantageous, because the flex cracks preferably occur at the weakest locations of the abrasive and accordingly directly on the abrasive elements, whereby an outbreak of the abrasive elements (grain break-out) can be favored.

In the present case, with the aid of a depression recess, flexibility can be increased and a breakout of abrasive elements can be reduced.

By means of the depression recess, a thickness of the abrasive can be reduced. In particular, the thickness of the abrasive can be reduced to the thickness of the carrier element.

This allows particularly inflexible abrasive to be designed more flexibly. Thicker abrasive in particular are provided for flexibility.

As a result, in particular thicker abrasive, which are formed from a fabric, a composite, a fiber material, etc., for example, can be designed more flexibly.

As a result, a stripping performance of the abrasive material can be increased, even when using “hard” binder element preparations. Accordingly, the abrasive elements can abrade more effectively, and also fewer abrasive elements can be employed. In addition, the chip space for receiving abrading particles is increased, thereby causing the abrasive to be used less frequently. Despite the “heavy” overall construction with a base weight of at least 1000 g/m\hat{ }2, in particular at least 1200 g/m\hat{ }2, preferably less than 2000 g/m\hat{ }2, the abrasive is very flexible.

The base binder element can be formed from in particular 60 g aqueous phenolic resin (75%), in particular 40 g chalk, and, in particular 30 g water. The viscosity of the preparation can be sufficiently low. The preparation can be filled high with fillers, in particular despite a low viscosity. As a result, the abrasive element cannot tip over after scattering.

This will temporarily lower viscosity and vaporize some water.

Alternatively or additionally, non-aqueous bicomponent systems (e.g. polyurethane) can also be used.

It can be expedient for the first depression recess to extend, in particular in a straight line, from a first end of the abrasive to a second end of the abrasive facing away from the first end.

For the later flexibility, it is advantageous to select the structure of the base binder application and, consequently, the grain in such a way that straight lines can be drawn through the abrasive from several directions which do not strike abrasive grain.

It can be expedient for the abrasive to have a second depression recess, in particular a second slot recess, which is arranged in the base binder element and/or the cover binder element.

It can be expedient for the abrasive to have a third depression recess, in particular a third slot recess, which is arranged in the base binder element and/or the cover binder element.

It can be expedient for the first depression recess to be arranged transversely, in particular orthogonally, to the second depression recess.

It can be expedient for the abrasive to comprise a first group of abrasive elements and a second group of abrasive elements and/or a third group of abrasive elements, wherein the recess is arranged between the two groups, in particular separating them.

It can be expedient for the first group of abrasive elements to be limited by the first depression recess, the second depression recess, and the third depression recess.

The invention further relates to a method for producing an in particular flexible abrasive, in particular according to any of the preceding claims, comprising the steps of:—providing a carrier element for assembling an abrasive element on the carrier element; providing a base binder element for holding the abrasive element on the carrier element; providing a cover binder element for covering the abrasive element and/or the base binder element; forming a depression recess in the abrasive, in particular the base binder element and/or the cover binder element, by means of a laser cutting process.
separating the base binder element and/or the compression binder element by means of a laser.

Alternatively or additionally, the entire abrasive, in particular the base binder element, the cover binder element and/or the carrier element, can be cut through entirely by means of the laser. The depression recess can extend from one side of the abrasive to a side of the abrasive facing away from the one side.

It can be expedient for the abrasive to be deflected in one step by means of an in particular flexible rolling element. The rolling element can be arranged on the abrading region of the abrasive. The rolling element can deflect the abrasive along the abrading region of the abrasive. Alternatively or additionally, the rolling element can be arranged at a region facing away from the abrading region, i.e. a holding region, of the abrasive, and/or deflect the abrasive along the region. The abrasive can be thereby drawn over an edge or pressed into the rolling element with a small radius by means of a rod element, in particular a metal rod element. Thus, the binder element can break into small pieces of a few square millimeters, while the carrier element ideally remains undamaged due to its flexibility.

To support the deflection method, the binder elements (base binder element and/or cover binder element) can be flexibilized by means of a polymer dispersion, for example.

As a result, the abrasive can additionally be flexibilized by providing flex cracks in specified regions or on the depression recesses. In particular, the flex cracks are to be introduced into the base binder element or the cover binder element at the “target breaking points” formed by the depression recess.

It can be expedient for the carrier element to be scattered with a plurality of abrasive elements in one step, in particular by means of electrostatics or compressed air.

It can be expedient in one step for the base binder element to be heated, in particular after an assembly of the base binder element, in particular briefly heated, preferably by means of an IR radiator.

The invention further relates to a method for producing an in particular flexible abrasive, in particular according to any of the preceding claims, comprising the steps of:—providing a carrier element for assembling a plurality of abrasive elements on the carrier element; providing a base binder element for holding the abrasive element on the carrier element; and assembly of the abrasive element such that the, in particular all, abrasive elements protrude in relation to the base binder element.

Abrasive elements should be able to be placed in a targeted manner by means of the method. In particular, a number of abrasive elements to be placed per surface can be defined. In particular, all abrasive elements can be placed such that the, in particular all, abrasive elements protrude in relation to the base binder element. By placing abrasive elements in a targeted manner, it can be prevented that an abrasive element, in particular a longitudinal extension of the abrasive element is arranged on the carrier element, for example transversely, in particular parallel.

As a result, process-related conditions, for example, differently sized abrasive elements or differently sized layer thicknesses of the base binder element, can be balanced. Differently sized abrasive elements can occur in broken and/or grown abrasive elements, for example diamonds. The abrasive elements can be oriented in different directions due to a scattering operation, for example electrostatic scattering, and thus may protrude at different heights. Consequently, when abrading, only the abrasive grains that incidentally protrude highest or protrude highest come into contact with the workpiece.

By means of the present method, material costs can be saved.

It can be expedient for the abrasive elements to be aligned as a function of an abrading plane of the abrasive. The abrasive elements can be oriented at a specified distance from the carrier element.

It can be expedient that the abrasive elements are arranged with a first respective end facing the carrier element and a second respective end facing away from the carrier element. The second end can be arranged at a predetermined distance from the carrier element, in particular a side or face of the carrier element facing away from the abrasive element.

In particular, the, in particular all, abrasive elements can form an abrading plane, which can have a specified distance from the carrier element, in particular a side or face of the carrier element facing away from the abrasive elements. As a result, deviations in an in particular local thickness of the carrier element and the base binder element can be balanced. As a result, a uniform abrading pattern and a higher tool life (through a higher number of abrasive elements working simultaneously) can be achieved.

It can be expedient that a receiving unit is provided for receiving the abrasive element, in particular electrostatically.

The receiving unit can comprise a plurality of receiving recesses. The receiving recesses can be provided for receiving abrasive elements. In particular, a single receiving recess can be provided for a single abrasive element. The receiving recesses can be spaced apart from each other.

The receiving recesses can be configured as through-openings or blind holes. To better receive and stabilize abrasive elements, the receiving recesses can be funnel-shaped.

The receiving unit can be scattered with a plurality of abrasive elements by means of electrostatics or compressed air. The receiving unit can receive the abrasive elements on an outer side. The abrasive elements can be oriented on the receiving unit in an upright position by means of electrostatic scattering. The abrasive elements can be actively refused by a reloading (discharge) upon contact with the receiving unit, provided the abrasive elements do not strike a receiving recess.

The receiving unit can hold the abrasive elements on the receiving unit by means of a negative pressure. The abrasive elements can be held by the receiving unit, provided the abrasive elements are on the correct “spots” in the receiving recesses. A plurality of abrasive elements over a single receiving recess (competition around one receiving recess) can cause leakage and thus a loss of negative pressure. As a result, a holding force for holding the abrasive elements can be too low in order to hold the abrasive elements on the receiving unit. The abrasive elements can thereby be electrostatically discharged, and in particular actively rejected.

It can be expedient for a delivery unit to be provided which delivers the abrasive elements, in particular in a placing manner, onto the abrasive, in particular the base binder element. Depending on the size or an extension of the abrasive elements, the abrasive elements can be inserted or compressed differently in the base binder element. The abrasive elements, in particular the abrading tips of the abrasive elements, can thereby be arranged at a height or at the abrading plane.

To the extent that the delivery strikes a region of the carrier element without a base binder element, the abrasive element is not delivered by the delivery unit.

Optimally, the base binder element can have a specified yield strength, which is formed in particular by a pasty state. This can be achieved by fillers such as brown corundum.

The adhesive force of the base binder element can be greater than the holding force on the receiving unit, in particular due to the negative pressure. To fine-tune the holding force, the negative pressure of the receiving unit can be controlled.

It can be expedient that the delivery unit has a distance from the carrier element, in particular from a side or face of the carrier element facing the abrasive elements, that is greater than a thickness of the base binder element. As a result, it can be ensured that the base binder element does not come into contact with the delivery unit.

It can be expedient for the receiving unit and/or the delivery unit to be configured as a rolling unit, in particular as a perforated rolling unit. The receiving unit and the delivery unit can be electrically conductive.

In an alternative embodiment, the receiving unit and/or the delivery unit can be configured as a plate unit, in particular a perforated plate unit.

It can be expedient for the receiving unit to comprise a non-stick coating. In this way, a soiling and adhering of a base binder element to regions not occupied by abrasive elements can be prevented. Optimally, the non-stick coating has an electrical conductivity that is, in particular, low enough so as to discharge incorrectly placed abrasive elements and to allow them to fall back. This can be particularly advantageous for fine abrasive elements, in particular.

### BRIEF DESCRIPTION OF THE DRAWINGS

Further advantages follow from the description of the drawings below. Exemplary embodiments of the invention are shown in the drawings. The drawings, the description, and the claims contain numerous features in combination. A person skilled in the art will appropriately also consider the features individually and combine them into additional advantageous combinations. The drawings show:

FIGS. 1a to 1e various views of an abrasive element,

FIG. 2 a cross-section through an abrasive,

FIGS. 3a to 3d, various views of the producing of an abrasive,

FIGS. 4a to 4l, various views of the producing of an abrasive,

FIGS. 5a to 5h, various views of the producing of an abrasive,

FIGS. 6a to 6c various views of the producing of an abrasive; and

FIGS. 7a to 7e various views of the producing of an abrasive.

In the following figures, like components are provided with like reference numerals.

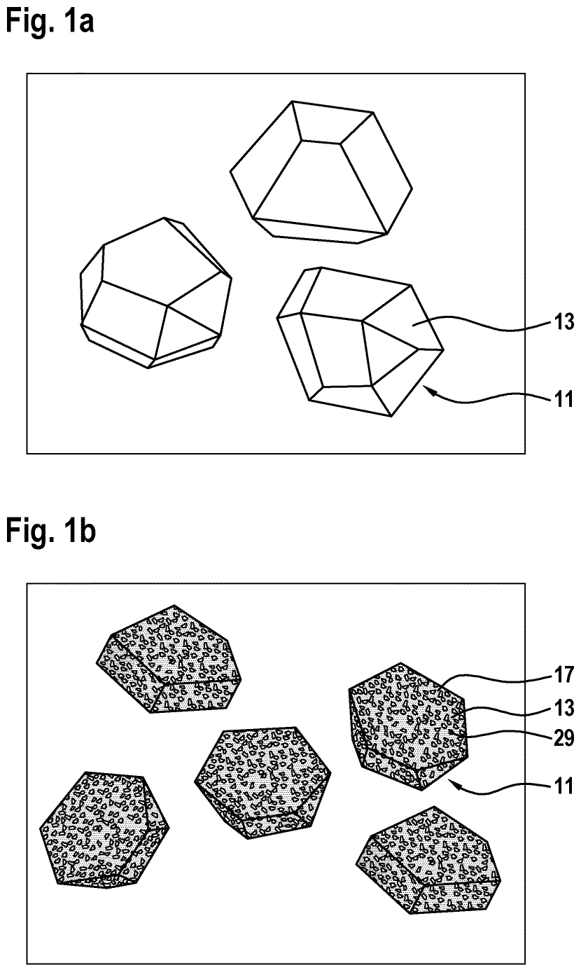

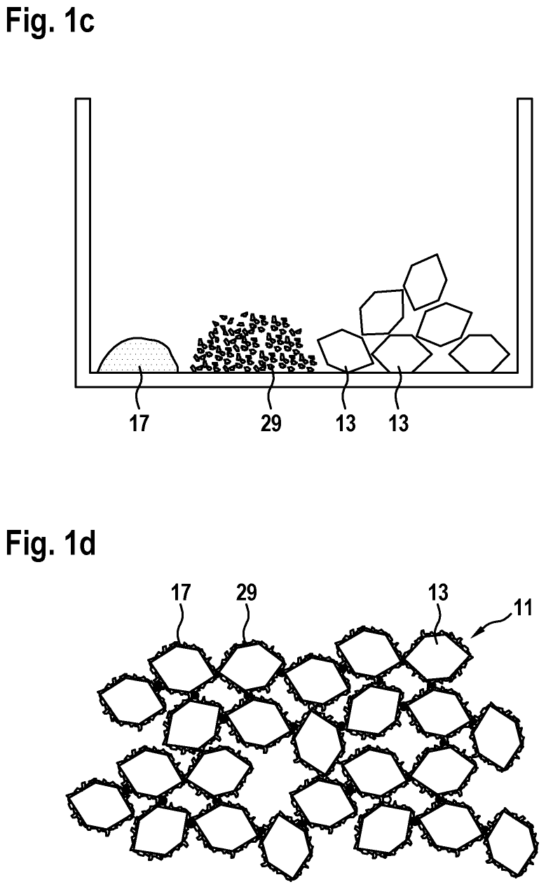

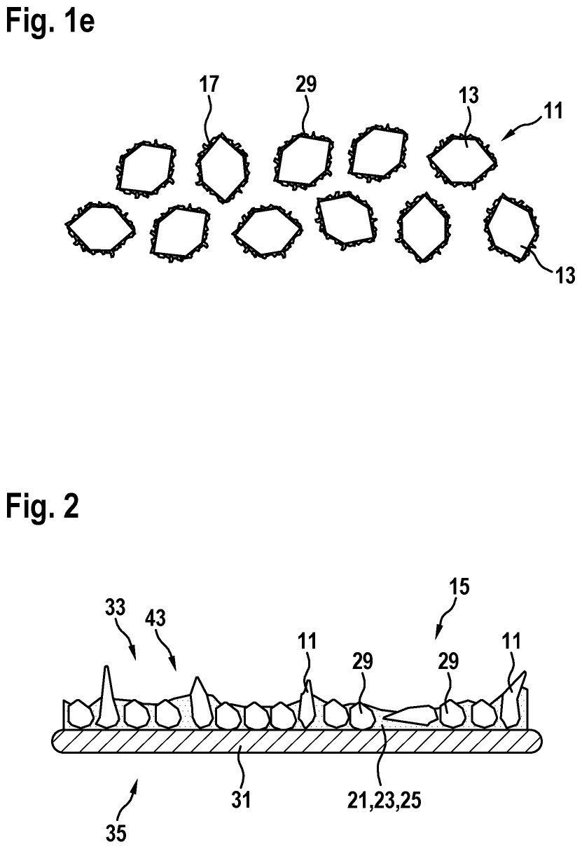

FIG. 1b, FIGS. 1d to 1e, show an abrasive element 11 for a flexible abrasive 15 configured as an abrasive disc (FIG. 2) for abrading a workpiece with a main abrasive element 13.

The abrasive element 11 comprises an adhesive element 17, which is arranged on the main abrasive element 13 and is configured as an adhesion promoter 17. The adhesive element 17 is arranged between a binder element and a main abrasive element so as to increase an adhesion of the main abrasive element 13 in relation to a binder element 21, 23, 25. Accordingly, the adhesive element 17 forms an adhesion promoter 17 for a binder element 21, 23, 25.

The binder element 21, 23, 25 comprises a base binder element 23 and a cover binder element 25. The base binder element 23 is provided so as to cover the carrier element 31 and the abrasive element 11. The cover binder element 25 is provided so as to cover the carrier element 31, the base binder element 23, and the abrasive element 11. The base binder element 23 and the cover binder element 25 are configured as layers on the carrier element 31.

The adhesive element 17 is configured as a coating. The adhesive element 17 completely surrounds the main abrasive element 13, but can also be arranged in sections on the main abrasive element 13.

The abrasive element 11 comprises a plurality of support elements 29 arranged on the main abrasive element 13 for supporting the main abrasive element 13 (FIG. 1d). The support elements 29 are distributed uniformly across the entire exterior or surface of the main abrasive element 13. The support element 29 is arranged directly on the main abrasive element 13 and contacts it.

The adhesive element 17 completely surrounds the main abrasive element 13 and the support element 29. The adhesive element 17 is arranged between the main abrasive element 13 and the support element 29 and completely surrounds the main abrasive element 13 and the support element 29.

The adhesive element 17 holds a plurality of support elements 29 on the main abrasive element 13. The support elements 29 are arranged on an exterior region of the main abrasive element 13 and are distributed over the entire exterior region of the main abrasive element 13. The support elements 29 are enveloped by the adhesive element 17 and are arranged on the main abrasive element 13 and surrounded by the adhesive element 17 in such a way that a plurality of uneven surface portions of the abrasive element 11 result (FIG. 1d).

The main abrasive element 13 is provided for abrading a workpiece and has a deforming and/or stripping effect on a workpiece to be machined. The main abrasive element 13 is configured as an abrading body and is known as an abrasive grain, among other things.

The main abrasive element 13 can be configured as a broken or a shaped main abrasive element 13. In particular, when using broken main abrasive elements 13, it typically cannot be ensured that the main abrasive elements 13 have approximately equal longitudinal extensions (FIG. 2), as a result of which the main abrasive elements 13 may protrude at different lengths on the abrasive 15 and can lead to a non-uniform abrading pattern or stripping.

The main abrasive element 13 is not limited to specific main abrasive elements 13. The main abrasive element 13 can be, for example, corundum (in various forms, in particular white corundum, semi-electrical corundum, blue corundum, zirconia ceramic corundum, and/or brown corundum), silicon carbide, cubic boron nitride, diamond, or mixtures thereof. The main abrasive element 13 (FIGS. 1a to 1e) is formed from a diamond and accordingly exhibits a low chemical bond to the phenolic resin due to a typically block-like shape or surface and a plurality of flat faces (no textured faces), which may lead to cracks in the abrasive 15 or between the main abrasive element 13 and phenolic resin during a machining operation. Small gaps between the main abrasive element 13 and the binder element 21, 23, 25 can quickly lead to a break-out of the abrasive element 11 from the abrasive 15 due to the lack of textured surfaces. Due to the cost, the support element is formed from a material which is different from the main abrasive element. The adhesive element 17 is formed from a two-component polyurethane, whereby a good adhesion to, for example, a diamond surface is achieved. The adhesive element 17 serves as an adhesion promoter 17 between the main abrasive element 13 formed from diamond and the binder element 21, 23, 25 of the abrasive 15 formed from phenol resin.

With some exceptions, each extension of the main abrasive element 13 is at least 100% larger than each extension of the support element 29. With some exceptions, each volume of the main abrasive element 13 is at least 100% greater than each volume of the support element 29.

Because it cannot be ensured that each individual main abrasive element 13 or each individual support element 29 falls under the limitation(s) described above, due to the plurality of main abrasive elements 13 and/or each individual support element 29, an extension is understood here to mean a plurality of elements, in particular, and a volume is understood to mean an average volume of a plurality of elements.

The support element 29 is arranged directly on the main abrasive element 13. The support element 29 is provided so as to support the main abrasive element 13 in a usage state. The support element 29 is provided so as to increase a firmness, a heat resistance, and a toughness of the abrasive 15. The support element 29 is provided for admixing with the main abrasive element 13. The support element 29 is arranged between two main abrasive elements 13 and is provided so as to space the two main abrasive elements apart from each other. The support element 29 is provided so as to increase a surface or exterior of the main abrasive element 13 in order to prevent a break-out of the main abrasive element 13. The support element 29 is provided so as to reduce or prevent a deflection of the main abrasive element 13, in particular in a usage state, in order to achieve a better abrading effect. The support element 29 has a high mechanical strength and is provided as an admixture to the main abrasive element 13.

The abrasive 15 has a longitudinal extension or—in the case of a disc—a diameter of up to 500 mm.

The abrasive 15 has a thickness of up to 5 mm.

The abrasive 15 comprises a flexible carrier element 31 for the assembly of the abrasive element 11 by means of a binder element.

The abrasive element 11 is largely integrated or embedded in the base binder element 21, 23 during the manufacture of the abrasive 15. During an abrading operation, the cover binder element can wear down during the machining operation and can expose the main abrasive elements 13. Further wear of the cover binder element 25 can be prevented by the exposed main abrasive elements 13. During such a “abrading-in operation,” support elements 29 located on the exposed surface of the main abrasive element 13 can also be stripped away, while the further support elements 29 located on the side facing away from the workpiece are not affected.

The abrasive 15 has a plurality of abrasive elements 11 on a surface of the carrier element 31 which protrude from the carrier element 31 and limit the abrasive 15.

The abrasive 15 is configured as a circular abrasive disc and is used for abrading or abrasive machining of a workpiece during which material of the workpiece is mechanically stripped from the surface of the workpiece in the form of chips. The abrasive 15 is a coated abrasive 15 (FIG. 2).

The base and/or cover binder element 23, 25 are provided for a material-locking connection of the abrasive elements 11 and the carrier element 31 of the abrasive 15.

The carrier element 31 of the abrasive 15 can comprise any flexible substrate that is common in the abrasive industry. The carrier element 31 is preferably formed from a textile, a paper, or a foil material. The carrier element 31 is formed from a plurality of layers.

The abrasive elements 11 can be placed onto the support layer and fixed by means of the base binder element 23. By means of the base binder element 23, the abrasive grains can be pre-fixed in the desired position and distribution on the carrier element 31.

The abrasive 15 can contain one or more cover binder elements 25, in particular layers of cover binder elements 25. In the case of two layers of cover binder elements 25, the lower cover binder element 25 is commonly referred to as “cover binder 1” or “size coat” and the upper cover binder element 25 as “cover binder 2” or “supersize coat.” The topmost cover binder element 25 can be uncured, i.e. the cover binder element 25 forming the outermost layer and facing away from the carrier element 31 of the abrasive 15. The cover binder elements 25 can be applied in particular layer by layer onto the base binder element 23 and the abrasive elements 11. The cover binder element 25 securely connects the abrasive elements 11 to one another and to the carrier element 31. The abrasive 15 can have a holding side 35 and an abrading side 33 facing away from the holding side. The abrasive 15 is limited on the holding side 35 by a holding face and limited on the abrading side 33 by an abrading face.

The holding side 35 comprises a fastening means (not shown in detail), which is provided for assembling the abrasive 15 on an abrading plate of a machine tool. The fastening means can comprise a mechanical connecting element, for example a hook-and-loop fastener, a screw fastener, or a clamp fastener, or an adhesive connecting element, such as a glue fastener.

The base binder element 23 and the cover binder element 25 are formed from a phenolic resin. The base binder element 23 and the cover binder element 25 can also contain other common active ingredients and/or fillers.

A producing method for producing the abrasive element 11 comprising the step of providing the main abrasive element 13 and the support element 29. In a further step, a material-locking connection of the support element 29 and the main abrasive element 13 is produced by means of an adhesive element 17.

As a result, the main abrasive elements 13 and the support elements 29 can be provided in a suitable number and quantity as a bulk material. The adhesive element 17 producing the material-locking connection can be present in liquid, in viscous, and in paste-shaped forms. A mixing apparatus can be used in order to create a material-locking connection of the support element 29 and the main abrasive element 13, by means of which the adhesive element 17 can be distributed around the support elements and the main abrasive element.

To receive the mixture or main abrasive element 13, the support element 29, and the adhesive element 17, the mixing apparatus can comprise a receiving unit. In a receiving state, the receiving unit is open for receiving the mixture and in a closing state, the receiving unit is closed for avoiding or preventing unwanted leakage of the mixture. The receiving unit is configured as a receiving drum.

For mixing the mixture, the mixing apparatus comprises a mixing unit having a mixing element, which is configured as a screw mixer, a paddle mixer, or the like. The mixing element is arranged entirely in the receiving unit and is mounted movably or immovably in relation the receiving unit.

The mixing unit transfers an appropriate mixing movement of the receiving unit and/or the mixing unit to the mixture in order to mix the mixture. The mixing element contacts the mixture directly or indirectly.

The mixing apparatus comprises a driving unit that drives the receiving unit and/or the mixing element and moves them relative to each other.

The coating of the abrasive elements 11 with the support elements 29 is carried out by mixing the abrasive element 11 with the support element 29 and the adhesive element 17 to be used, for example at room temperature. The adhesive element 17, in particular along with the support element 29, can be distributed over the abrasive element 11 due to the surface tension, in particular relatively homogeneously.

In a further step, the mixture is cured by means of a curing unit. The mixture can occur during the mixing process or subsequent to the mixing process.

After the mixing operation of the mixture, the mixture can be cured in a heating unit configured as an oven unit at a temperature of more than 50 °C. Typically, the mixture can be cured for more than 5 min by means of the heating unit. The main abrasive elements 13 coated with the adhesive element 17 can be glued to further main abrasive elements 13 (FIG. 1d).

Optionally, in a further step, during or after curing, an electrically conductive material can be applied to the coated main abrasive element 13 or the abrasive elements 11. The electrically conductive material is configured as an organic compound configured as at least one ionic liquid and/or conductive polymer. The organic compound can either be applied in a pure form to the abrasive grain and/or as a solution dissolved in a solvent, for example in water, on the abrasive grain. Such an organic compound for an abrasive element 11 (hereinafter “abrasive grain”) is disclosed in patent application DE102017204605A1. In this regard, reference is made to the application DE102017204605A1, the contents of which are hereby incorporated in this application.

During or after curing, the abrasive elements 11 can be individually linked due to the adhesive element 17. As a result, the related abrasive elements 11 can be broken and separated in a further step by means of a separating unit. The separating unit comprises a separating element for separating the glued mixture, which is configured as a separating ball and applies a mechanical force to the mixture in order to separate the glued main abrasive elements 13 and abrasive elements 11 from one another.

For simplification of the separation process, the mixture in the heating unit can be rotated during the curing process, for example in the receiving unit.

The non-separated abrasive elements 11 can be separated from the individual abrasive elements 11 in a further step by means of a sieve unit and fed to the separating unit.

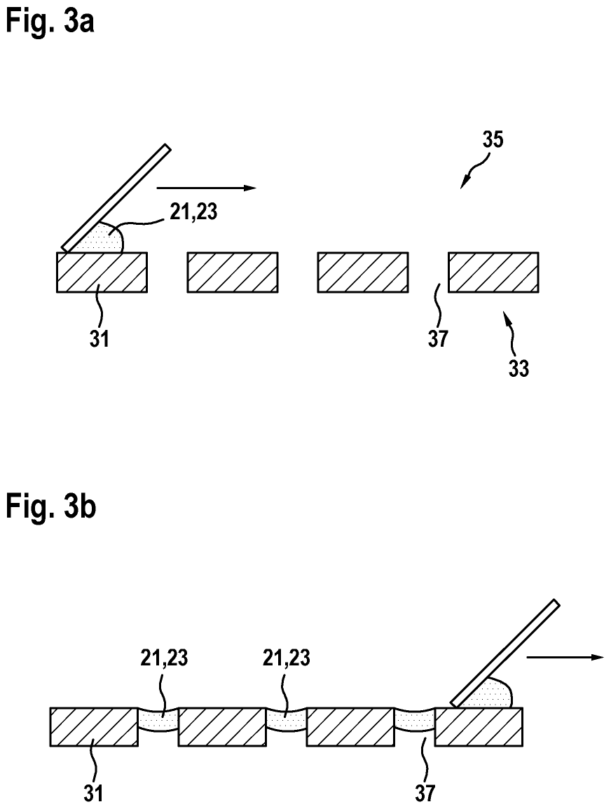

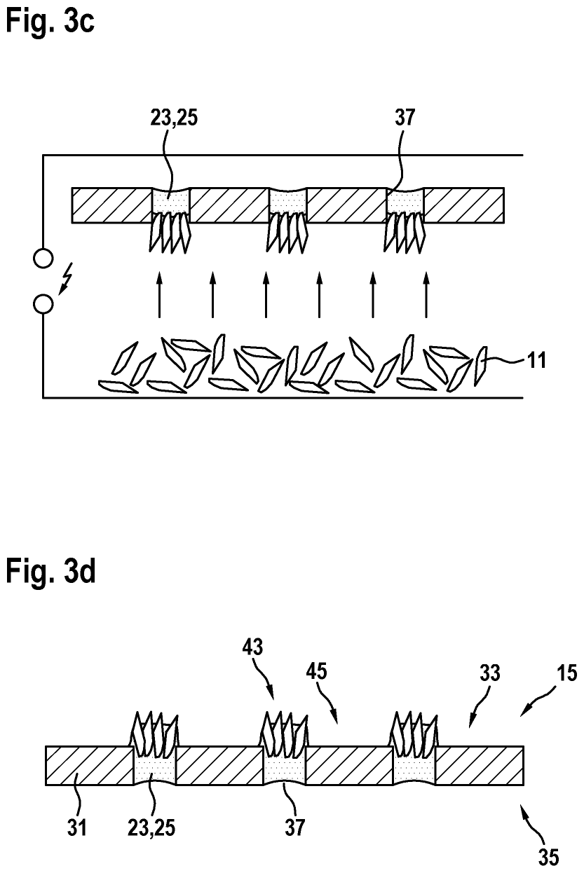

The carrier element 31 comprises a through-hole 37 for receiving an abrasive element 11 (FIGS. 3a to 3d), which extends through the entire carrier element 31. It is understood that a plurality of through-holes are provided in the carrier element. The through-holes 37 extend from the abrading side of the carrier element 31 to a holding side of the carrier element 31 facing away from the abrading side. The through-holes 37 are configured as a receiving opening for receiving abrasive elements 11. The through-holes 37 limit an assembly of abrasive elements 11 on the abrasive 15. The through-holes 37 align the abrasive elements 11. The through-holes 37 laterally support the abrasive elements 11. The through-holes 37 are configured such that the abrasive element 11 is indirectly or directly held in the through-holes 37.

Abrasive elements 11 arranged in the through-holes 37 can be surrounded by the carrier element.

The through-holes 37 can be arranged at a distance of at least 1 mm in relation to each other. Each through-hole 37 can have a hole diameter of at least 0.1 mm. The carrier element 31 can have a material thickness of at least 1 mm. The hole diameter of the through-hole 37 and the material thickness of the carrier element 31 can be adapted to the abrasive element 11, in particular a size of the abrasive element 11 (grain). As a result, a desired quantity of abrasive elements 11 (grain amount) can be applied.

The through-holes 37 can be introduced into the carrier element 31 by means of a stamping method, a laser method, a piercing method (for example, a needle roll), or the like.

When piercing, in particular by means of a piercing process, a beading (not shown) can be formed in the carrier element 31. The beading can surround the through-hole. The beading can be arranged on the rear side or on the holding side of the abrasive or carrier element 31. The beading can be configured as an elevation arranged around the through-hole and limiting the through-hole. The beading can form a depression associated with the beading on an abrading side. The beading, in particular the depression of the beading, can optimally align the abrasive elements.

The base binder element 23 is arranged on and in the through-hole 37 and completely fills the through-hole 37. The base binder element 23 limits the through-hole 37, thereby limiting an extension of the through-hole 37 through the carrier element 31. The base binder element 23 is arranged in the region of a side of the carrier element 31 facing away from the abrading side 33 (FIGS. 3a to 3d). The base binder element 23 limits the through-hole 37 on a side facing away from the abrading side 33. The passage element completely covers the through-hole 37.

The base binder element 23 can be configured as a foil element (not shown), in particular an adhesive foil element, which is arranged on the side of the carrier element 31 facing away from the abrading side 33. The base binder element 23 can be connected to the carrier element 31 over its full surface. The base binder element 23 can be arranged in a rigid form and/or in the form of a foil on one side of the carrier element 31 facing away from the abrading side 33.

The carrier element 31 can comprise an electrically conductive coating for aligning the abrasive elements 11 by means of an electrostatic field. The coating is arranged on a side of the carrier element 31 facing away from the abrading side 33. As a result, an electrostatic force can have a stronger effect in the breakthrough recess, as in neighboring regions, whereby the abrasive element 11 is preferably pulled towards the breakthrough recess.

A method for producing a flexible abrasive 15, comprising the step of providing a carrier element 31 for assembling an abrasive element 11 on the carrier element 31 and providing a through-hole 37 extending through the entire carrier element 31 for receiving abrasive elements 11.

In one step, a base binder element 23 is arranged on a side of the carrier element 31 and/or the through-hole 37 facing away from the abrading side 33. The base binder element 23 is not applied as usual on the abrading side 33 of the carrier element 31, but rather on a side facing away from the abrading side 33 of the carrier element 31 or on the holding side 35 of the carrier element 31.

The base binder element 23 can be applied to the carrier element 31 over its full surface by means of a squeegeeing method and in or over the through-hole 37. The base binder element 23 is applied to the carrier element 31 in a liquid state, in particular in a viscous state, preferably in a pasty state. The base binder element 23 remains stuck in the through-hole 37 due to the state and the surface tension.

In one step, the base binder element 23 can be applied to the carrier element 31 over its full surface in order to fully coat the carrier element 31. A layer or a foil of the base binder element 23 can remain on the carrier element 31. In a further step, a further layer, for example a velour, a cover paper, or an anti-slip coating, can be applied or laminated onto the base binder element 23.

As an alternative to the squeegee application of a liquid base binder element 23 by means of a squeegeeing method, the base binder element 23 can be configured as a foil element, in particular an adhesive foil element. The foil element can be arranged on the side of the carrier element 31 facing away from the abrading side 33 and can be arranged or glued on the carrier element 31. As a result, the carrier element 31 can be substantially “sealed” such that residues from a binder element on a side facing away from the abrading side 33 can be avoided. These residues can soil the producing rollers and make the producing process more difficult. As a result, a curing/drying/deactivation of the base binder element 23 arranged on the side facing away from the abrading side 33 can be omitted. Further, the use of a liquid base binder element 23 can be avoided.

When using a binder element configured as a foil element, a produced abrasive 15 can be rolled up and stored without a protective foil element, for example a wax paper, because the base binder element 23, for example a self-adhesive, can be held in the through-hole 37.

In a further alternative embodiment, a hot melt layer can be applied to the rear side of the perforated paper. This can be scattered from the opposite side either directly in a hot state or heated up again with an IR radiator before the scattering process, for example. The layer can also be utilized in order to apply a velour at the same time.

As an alternative to the perforated foil, an open fabric, in particular a textile (e.g. 50 g/m²) can be used, onto the rear of which an adhesive foil is applied. The grains then remain stuck in the fabric during the scattering process. The method has the advantage that a “mesh” is incorporated, and the abrasive 15 could therefore be marketed as “mesh abrasive.” Here, an adhesive foil, hot melt application, or liquid spread can also be used as the adhesive layer.

In one step, an abrading side of the carrier element 31 can be scattered with a plurality of abrasive elements 11 by means of electrostatics or compressed air.

In one embodiment of the method, the abrasive elements 11 can be electrostatically scattered onto the carrier element 31. The abrasive elements 11 are electrostatically charged in an external electrical field by electrostatic interaction with this external electrical field and accelerated onto the carrier element 31.

In the electrostatic scattering operation, those abrasive elements 11 can become stuck in the through-hole 47, which are aligned during the scattering operation substantially perpendicular to the abrasive 15, in particular to the abrading face. To the extent that the abrasive element 11 strikes the breakthrough recess substantially perpendicular to the abrasive 15, it is “suctioned” into the breakthrough recess by the surface tension of the base binder, whereby the abrasive element 11 is raised further in a perpendicular direction.

Abrasive elements 11 that are aligned substantially parallel to the abrasive 15, in particular to the abrading face, can be dismissed in that the abrasive elements 11 are discharged on the carrier element 31 and fall back. As a result, particularly advantageous bundles of abrasive elements 11 can be created, which are glued by means of the binder element arranged in or behind the breakthrough recess. The curing of the base binder element 23 as well as the application of the cover binder element 25 can occur classically, i.e. thermally, bicomponent, UV, etc. and are known to a person skilled in the art.

The amount of abrasive elements 11 can be determined by the hole diameter of the breakthrough recess and the amount of base binder element 23 arranged on the carrier element 31.

In one embodiment of the method, the sieve is realized in metal and operates as a high-voltage electrode during an electrostatic scattering. A counter-electrode for electrostatically scattering the abrasive elements 11 can be arranged behind the carrier element 31, in particular behind a carrier element product path, or itself realized by the carrier element 31, in particular by the carrier element 31 material web, provided it is electrically conductive or comprises an electrically conductive (e.g. aqueous or soot-filled) binder element 21, 23, 25. In this way, a particularly effective electrostatic scattering of the abrasive elements 11 can take place, in which a risk of agglomeration of the, for example, previously de-agglomerated abrasive elements 11 can be largely avoided.

In one step, abrasive elements 11, which are not arranged in the through-hole 37 and/or are held on the carrier element 31 by means of the base binder element 23, are removed.

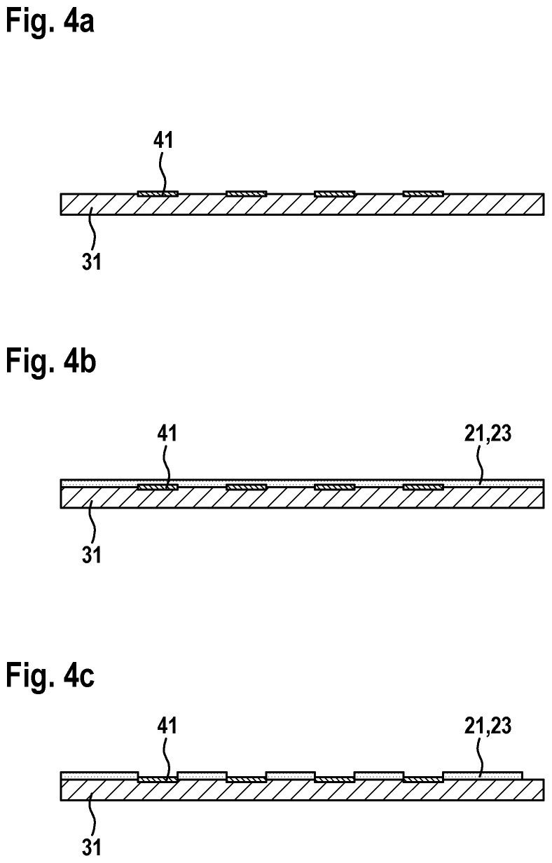

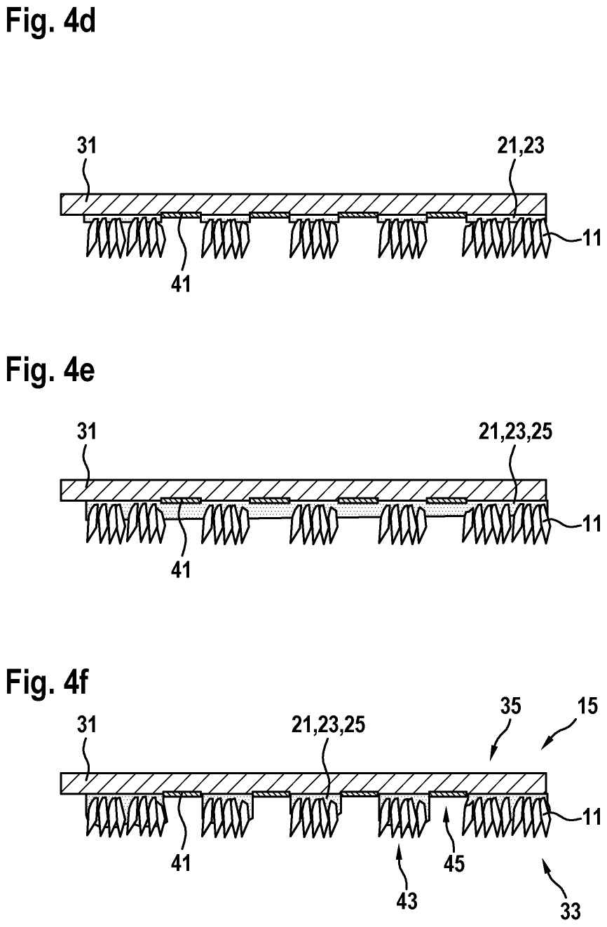

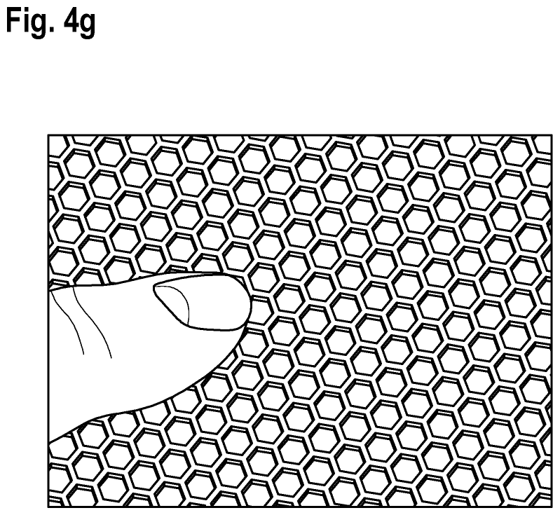

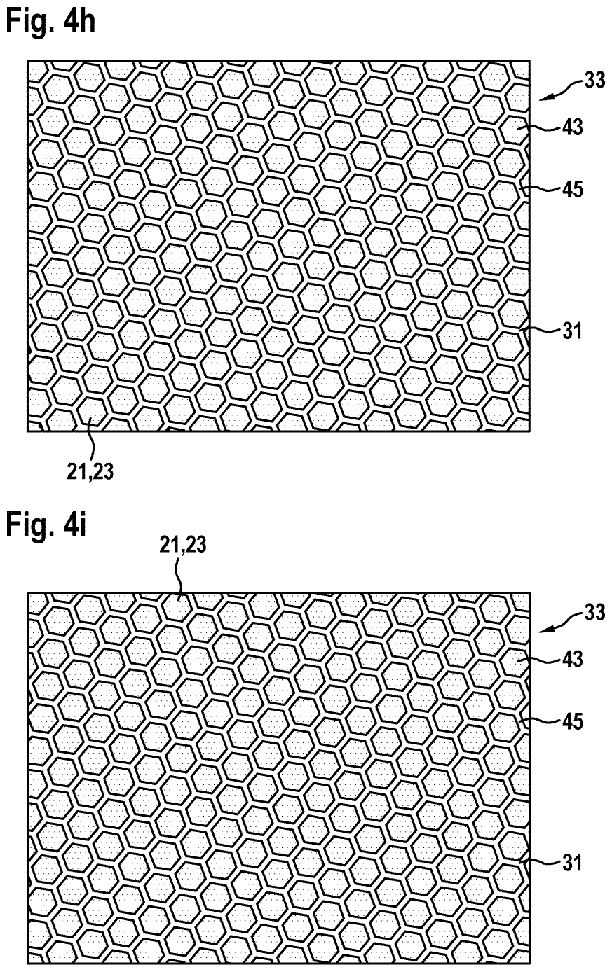

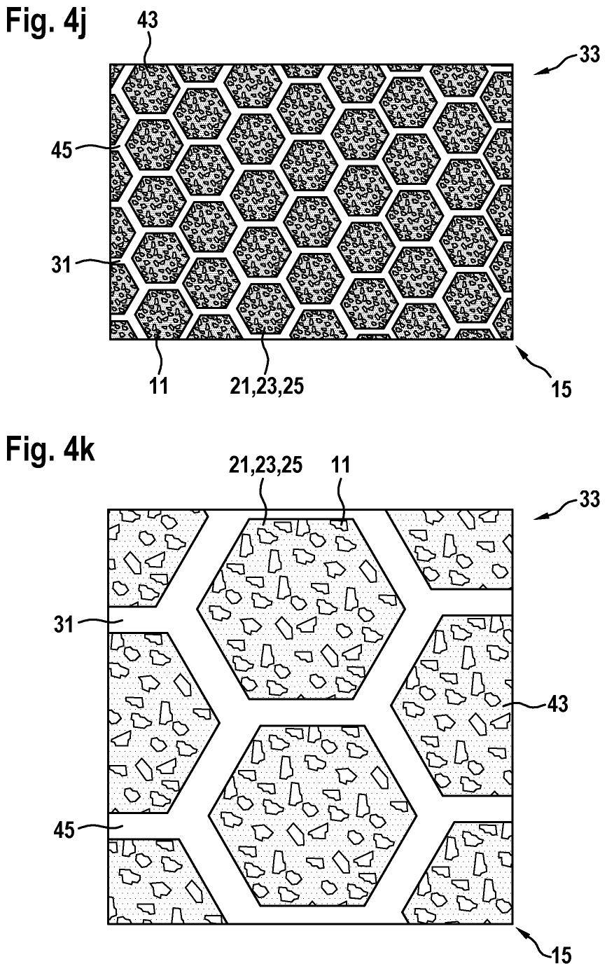

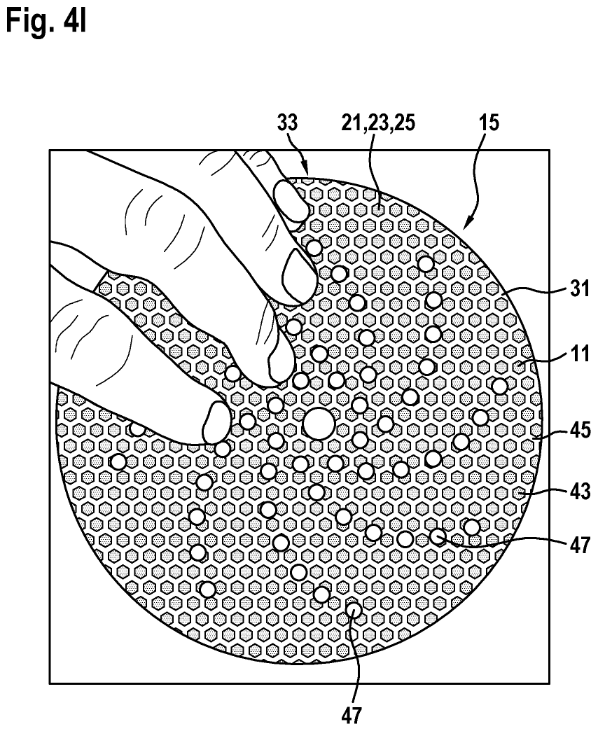

FIGS. 4a to 4l show a further development of an abrasive 15, which comprises an adhesion limiting element 41 arranged on the carrier element 31 for limiting an assembly of the base binder element 23 on the carrier element 31. It is understood that the carrier element 31 according to FIGS. 4a to 4l can also have through-holes 37 according to FIGS. 3a to 3d. For example, the adhesion limiting element 41 can be arranged around the through-hole 37 and in particular can completely surround it. The adhesion limiting element 41 can be arranged on the abrading side in order to ensure that the binder element, in particular the base binder element, is arranged in the through-hole 37. The adhesion limiting element 41 reduces or prevents an assembly of the base binder element 23 and the abrasive element 11 on the carrier element 31. The adhesion limiting element 41 is provided so as to displace or discharge a base binder element 23 arranged on the carrier element 31, in particular so that the adhesion limiting element 41 does not become enmeshed with the base binder element 23. The adhesion limiting element 41 is configured to as a type of “anti-stick element” or “stick-stop element” and is partially arranged on the carrier element 31 in order to cover a portion of the carrier element 31. The adhesion limiting element 41 is arranged directly on the carrier element 31 and extends along an entire length of the abrasive 15.

The abrasive 15 comprises an abrading region 43 and, adjoining the abrading region 43, a free region 45. The abrading region 43 is formed by and bounds the free region 45. The abrading region 43 is formed by a base binder element 23 limiting the abrading region 43. The, and in particular each, base binder element 23 can form or limit the abrading region 43. The abrading region 43 is formed from a plurality of base binder elements 23 spaced apart from one another. The base binder elements 23 are configured as base binder element points 23. The base binder elements 23 can be configured in the form of islands or base binder islands. The base binder elements 23 can have an extension or diameter of less than 3 mm, in particular less than 2 mm, preferably less than 1 mm, for example 0.7 mm. The base binder element 23 can be formed from a phenolic resin, urea resin, polyurethane resin, polyester resin, optionally also UV-curing, etc. The base binder element 23 can be cured for specific materials or as a function of the base binder element 23 used. The abrading region 43 is formed from a plurality of binder base elements 23, which are spaced apart from one another in a close assembly or in groups. The base binder elements 23 receive a plurality of abrasive elements 11 and keep them bundled on the carrier element 31.

The abrading region 43 is surrounded by the free region 45, and the abrading region 43 surrounds the free region 45. The free region 45 is substantially limited by a plurality of base binder elements 23 of the abrading region 43. The free region 45 is configured so as to be free from the, in particular each, base binder element 23.

The adhesion limiting element 41 is arranged on the, in particular on all, free regions 45 of the carrier element 31 or forms the free regions 45. The adhesion limiting element 41 can be printed on the carrier element 31. The base binder element 23 can be applied to the carrier element 31 over its full surface by means of a roller.

In addition, a cover binder element 25 can be rolled onto the carrier element 31 over its full surface by means of a roller.

The abrasive 15 can comprise an opening 47 configured as a suction port for suctioning of abrading dust, wherein the suction recess is limited at least in sections by the adhesion limiting element 41 (FIG. 4l). The opening 47 is arranged in the free region 45 and is spaced apart from the abrading region 43. The opening 47 extends through the carrier element 31 through the entirety of the abrasive 15. The opening 47 is configured as a breakthrough extending through the entire material thickness of the abrasive 15. The opening 47 is configured as a round hole. The opening 47 and the abrading region 43 limit the free region 45 in sections. The opening 47 is completely surrounded by the free region 45 in a plane by 360°. The opening 47 is limited by the free region 45.

The base binder element 23 is formed from more than 40 wt.-%, in particular more than 50 wt.-%, preferably more than 55 wt.-% and/or less than 80 wt.-%, in particular less than 70 wt.-%, preferably less than 65 wt.-%.

A producing method for producing a flexible abrasive 15, comprising the steps of providing a carrier element 31 for the assembly of an abrasive element 11 on the carrier element 31 and providing an adhesion limiting element for limiting an assembly of the base binder element 23 on the carrier element 31.

In one step, the base binder element 23 is attached to the carrier element 31 over its full surface by means of a rolling process.

In one step, the carrier element 31 is scattered with a plurality of abrasive elements 11 by means of electrostatics or compressed air.

In one step, the cover binder element 25 is attached to the carrier element 31 over its full surface by means of a rolling process.

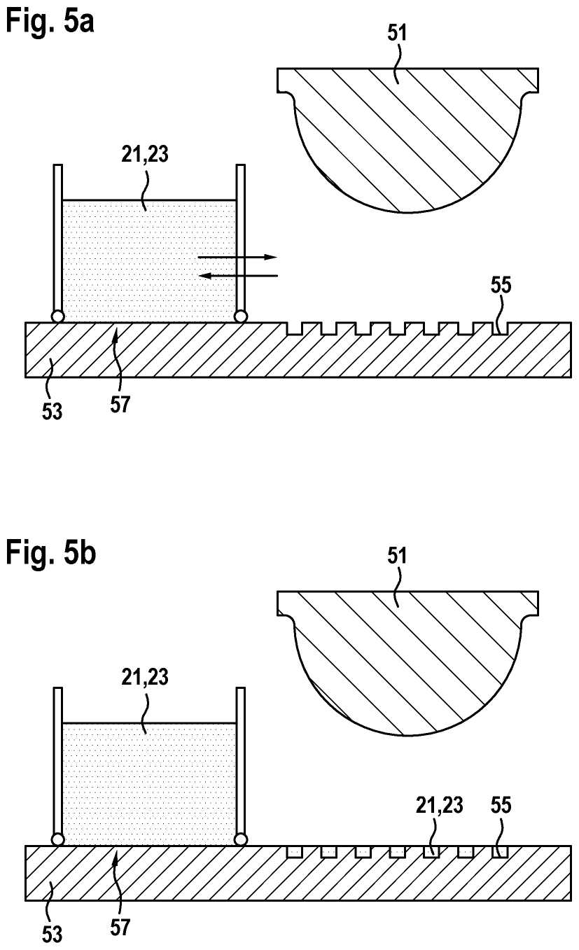

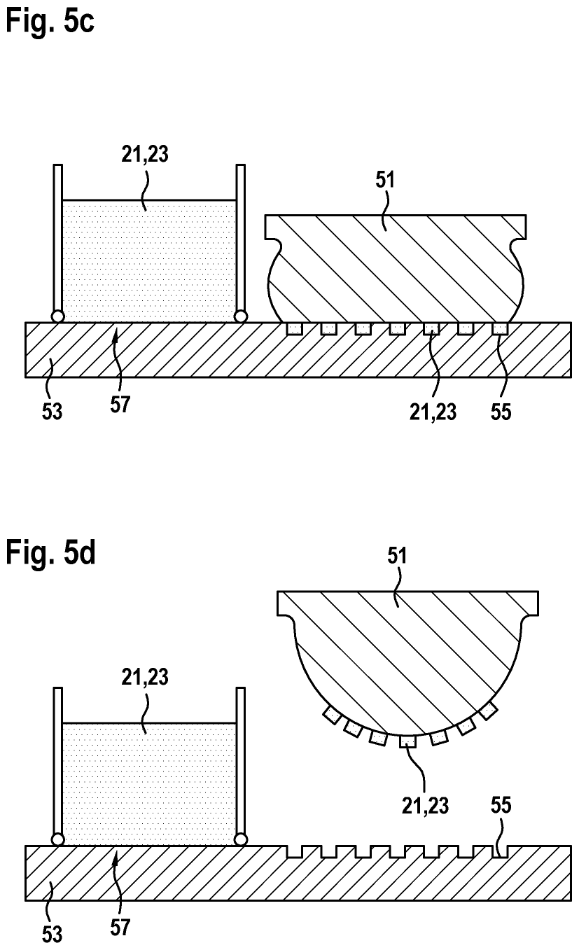

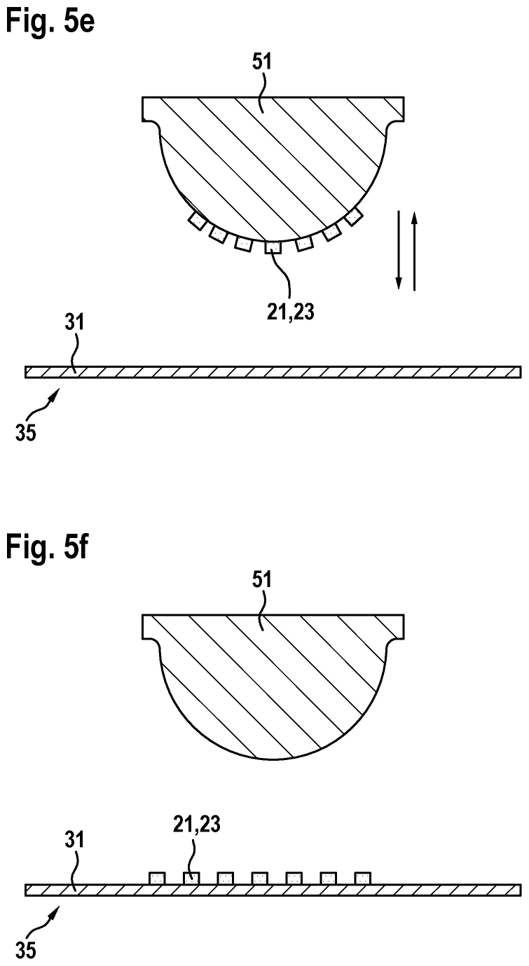

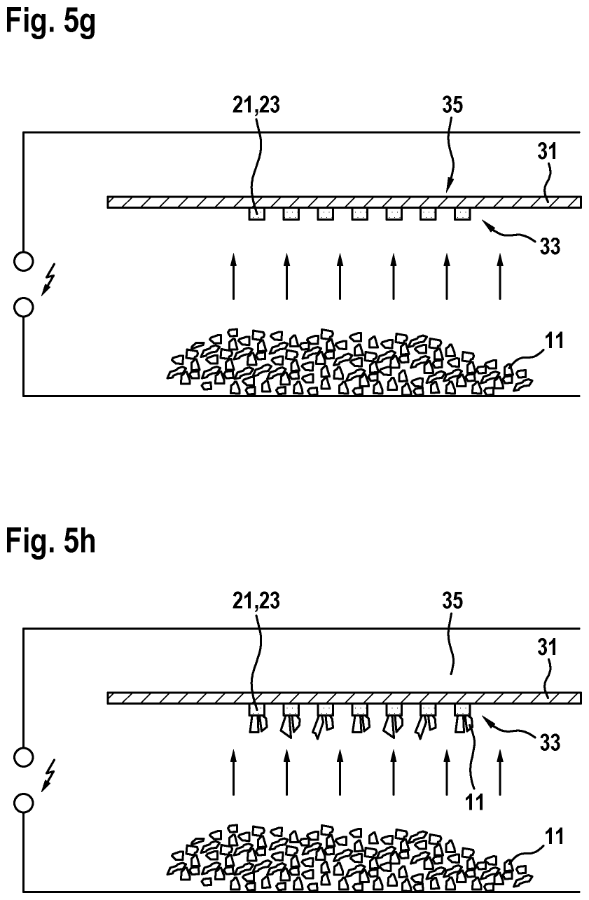

A producing method for producing a flexible abrasive 15, comprising the steps of providing a carrier element 31 for the assembly of an abrasive element 11 on the carrier element 31 and
providing a pad printing element 51 and/or a silicone roller element for assembling a base binder element 23 on the carrier element 31 (FIGS. 5a to 5h).

The pad pressure element 51 is provided for receiving and holding the base binder element 23. The pad pressure element 51 is provided for an assembly or a delivery of the base binder element 23 on the carrier element 31. The pad printing element 51 is formed from an elastic material, in particular a silicone material, preferably a silicone rubber.

The base binder element 23 is arranged on the carrier element 31 using a pad printing element 51 by means of a pad printing process. The pad pressure element 51 is configured as a pad stamp element. The pad printing process is configured as an indirect deep-drawing process. A transfer of the base binder element 23 to the carrier element 31 is carried out by pressing at different levels of contact force. The base binder element 23 is transferred onto the carrier element 31 by pressing the pad pressure element 51 using a pressing force.

In one step, a printing plate element 53 is provided for mapping a negative printing shape. The printing plate element 53 comprises a printing recess 55 for receiving the base binder element 23. For example, the printing plate element 53 can be formed from a metal, in particular a steel, or a plastic. The printing plate element 53 is limited by the printing recess 55, which is limited by the printing plate element 53 in a plane by 360°. The printing plate element is adapted to the shape or surface of the carrier element 31. The printing recess 55 is formed on the printing plate element 53 by means of a milling method, for example. The printing recess 55 forms a negative printing pattern, which is transferrable to the carrier element 31 by means of the pad pressure element 55.

In one step, a squeegee element 57 configured as a box squeegee element is provided for assembling the base binder element 23 on the printing recess 55 of the printing plate element.

The squeegee element is provided so as to arrange the base binder element 23 in the printing recess 55. The squeegee element is provided for receiving the base binder element 23 and stripping off a base binder element 23.

The cover binder element 25 is provided, wherein the cover binder element 25 is fully assembled on the carrier element 31 by means of a rolling process.

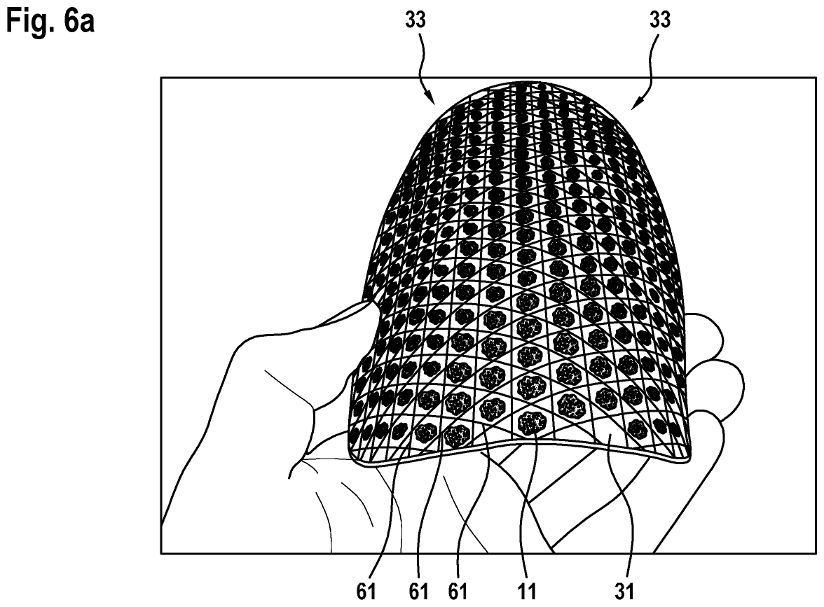

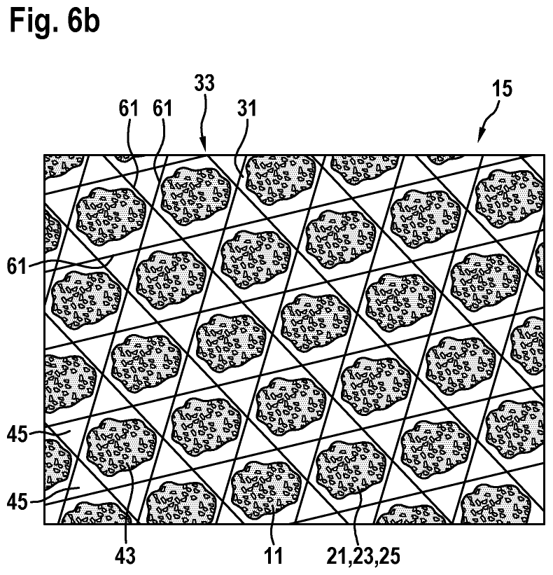

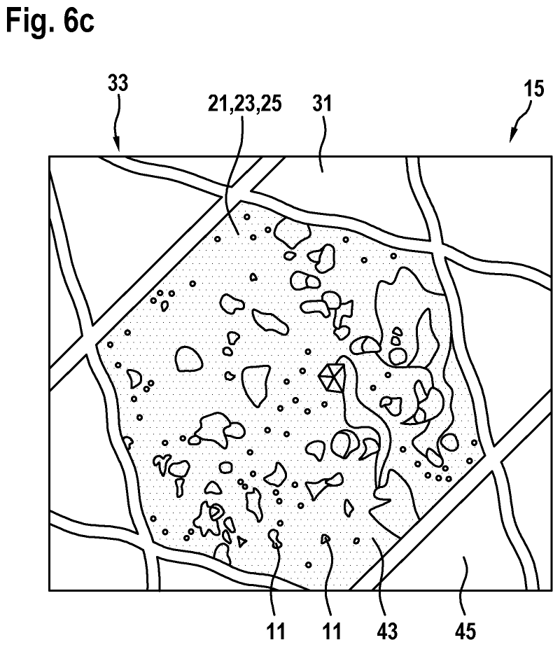

FIGS. 6a to 6c show an abrasive 15 having a first depression recess 61, which is arranged in the base binder element 23 and the cover binder element 25. The depression recess 61 is configured as a slot recess 61. The depression recess 61 is configured as a kind of target breaking point. The depression recess 61 limits the cover binder element 25 and the base binder element 23 and substantially separates the two elements from each other. The depression recess 61 defines a bending edge of the abrasive 15 and is limited by the carrier element 31. The depression recess 61 extends from a thickness of the abrasive 15 by at least 20% and by at most 90%.

The depression recess 61 is arranged in any region that is free of an abrasive element 11. The depression recess 61 is arranged spaced apart from one, in particular each, abrasive element 11.

The base binder element 23 is formed from in particular 60 g aqueous phenolic resin (75%), in particular 40 g chalk, and, in particular 30 g water.

The first depression recess 61 extends straight from a first end of the abrasive 15 to a second end of the abrasive 15 facing away from the first end.

The abrasive 15 comprises a second and a third depression recess 61 configured as a slot recess, which are arranged in the base binder element 23 and the cover binder element 25.

The first depression recess 61 is arranged transverse to the second and the third depression recess 61.

The abrasive 15 comprises a first group of abrasive elements 11 and a second group of abrasive elements 11, wherein the recess is arranged between the two groups and separates them. The first group of abrasive elements 11 is substantially limited by the first depression recess 61, the second depression recess 61, and the third depression recess 61.

A producing method for producing a flexible abrasive 15, comprising the steps of providing a carrier element 31 for assembling an abrasive element 11 on the carrier element 31 in order to provide a base binder element 23 for holding the abrasive element 11 on the carrier element 31 and providing a cover binder element 25 for covering the abrasive element 11 and/or the base binder element 23 and for forming a depression recess 61 in the base binder element 23 and cover binder element 25 by means of a laser-cutting process. By means of the laser, the base binder element 23, the cover binder element 25, and the carrier element 31 are completely cut through. The depression recess 61 can extend from an abrading side of the abrasive 15 to a holding side of the abrasive 15 facing away from the abrading side.

In one step, the abrasive 15 is deflected by means of a flexible rolling element. The rolling element is arranged on the abrading region 43 of the abrasive 15 and redirects the abrasive 15 along the abrading region 43 of the abrasive 15. Alternatively or additionally, the rolling element can be arranged at a region facing away from the abrading region 43, i.e. a holding region, of the abrasive 15, and/or deflect the abrasive 15 along the region. The abrasive 15 is thereby drawn over an edge or pressed into the rolling element with a small radius by means of a rod element, in particular a metal rod element.

To support the deflection method, the binder elements 21, 23, 25 (base binder element 23 and/or cover binder element 25) can be flexibilized by means of a polymer dispersion, for example.

In one step, the carrier element 31 is scattered with a plurality of abrasive elements 11 by means of electrostatics or compressed air. In one step, the base binder element 23 is heated for a short time by means of an IR radiator after an assembly of the base binder element 23.

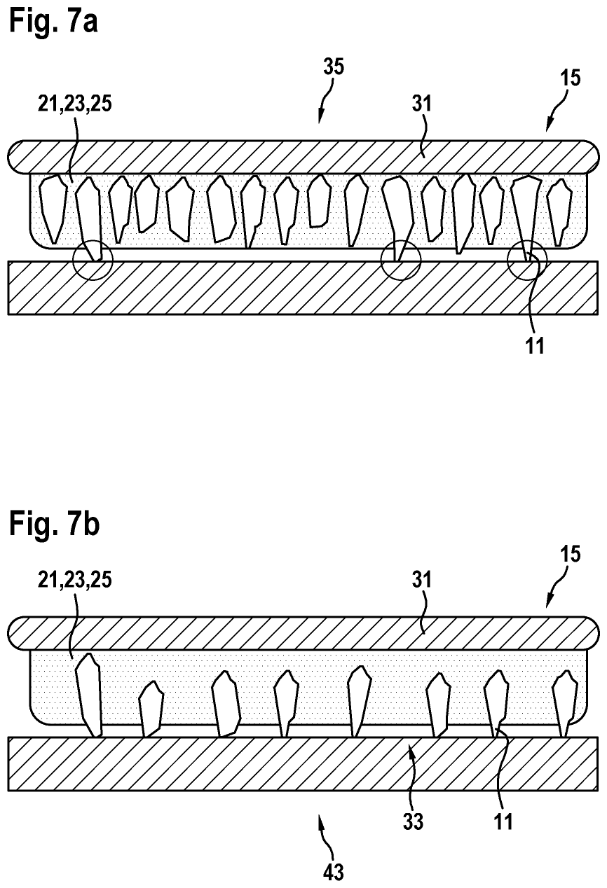

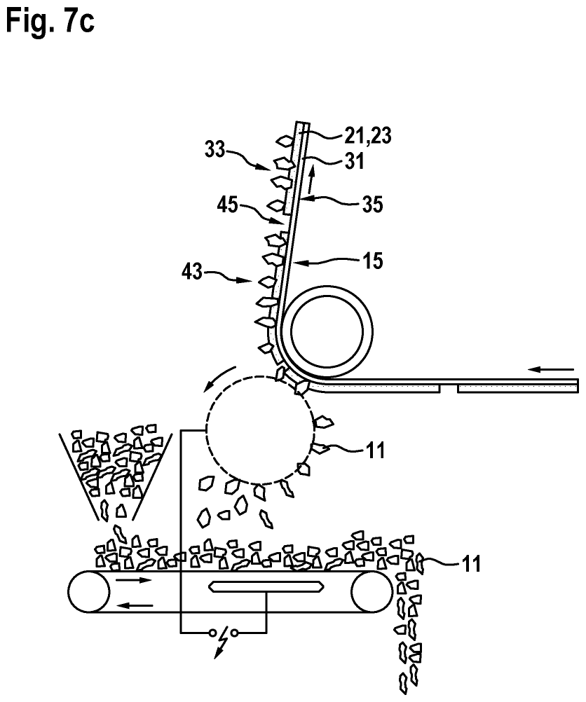

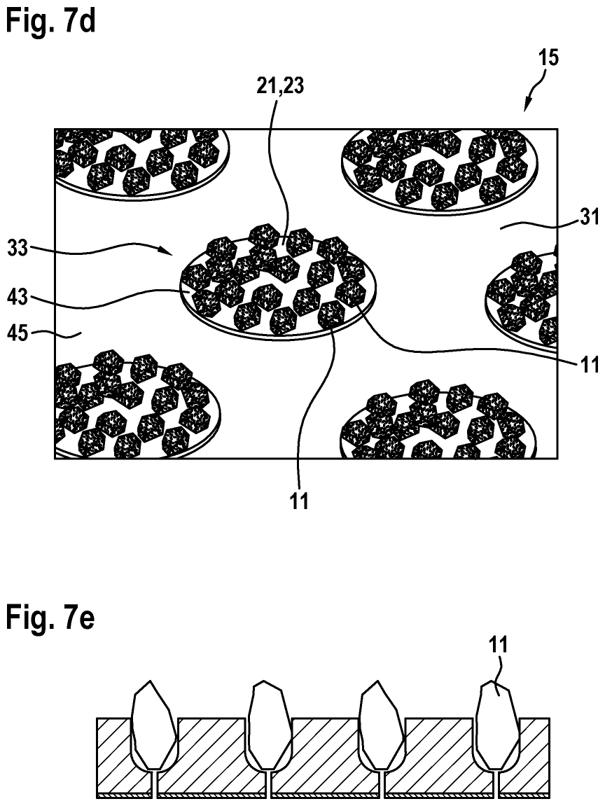

A producing method for producing a flexible abrasive 15, comprising the steps of providing a carrier element 31 for assembling a plurality of abrasive elements 11 on the carrier element 31 and providing a base binder element 23 for holding the abrasive element 11 on the carrier element 31 and assembling the abrasive elements 11 in such a way that the abrasive elements 11 protrude in relation to the base binder element 23 (FIGS. 7a. to 7e).

The abrasive elements 11 are aligned as a function of an abrading plane of the abrasive 15 and at a specified distance from the carrier element 31. The abrasive elements 11 are arranged with a first respective end facing the carrier element 31 and a second respective end facing away from the carrier element 31. The second end is arranged at a predetermined distance from the carrier element 31, i.e. a side or face of the carrier element 31 facing away from the abrasive element 11. The abrading tips of the abrasive elements 11 form an abrading plane, which has a specified distance from a side or face of the carrier element 31 facing away from the abrasive elements 11.

A receiving unit is provided for electrostatically receiving the abrasive element 11. The receiving unit comprises a plurality of receiving recesses, which are provided for receiving abrasive elements 11. In particular, a single receiving recess can be provided for a single abrasive element 11. The receiving recesses are spaced apart from each other. The receiving recesses are configured as through-openings 47 or as blind holes. To better receive and stabilize abrasive elements 11, the receiving recesses can be funnel-shaped.

The receiving unit is scattered with a plurality of abrasive elements 11 by means of electrostatics or compressed air and receives the abrasive elements 11 on an outer side. The abrasive elements 11 are oriented on the receiving unit by means of electrostatic scattering and can be actively refused by a reloading (discharge) upon contact with the receiving unit, provided the abrasive elements 11 do not strike a receiving recess.

The receiving unit can hold the abrasive elements 11 on the receiving unit by means of a negative pressure. The abrasive elements 11 can be held by the receiving unit when the abrasive elements 11 are in the receiving recesses. A plurality of abrasive elements 11 over a single receiving recess (competition around one receiving recess) can cause leakage and thus a loss of negative pressure.

A delivery unit is provided for the delivery of the abrasive elements 11 in a placing manner on the base binder element 23. Depending on the size or an extension of the abrasive elements 11, the abrasive elements 11 can be inserted or compressed differently in the base binder element 23.

To the extent that the delivery strikes a region of the carrier element 31 without a base binder element 23, the abrasive element 11 is not delivered to the carrier element 31 by the delivery unit.

The adhesive force of the base binder element 23 is greater than the holding force through the negative pressure on the receiving unit. To fine-tune the holding force, the negative pressure of the receiving unit is controlled.

The delivery unit has a distance from the side or face of the carrier element 31 facing the abrasive elements 11 that is greater than a thickness of the base binder element 23. The receiving unit and the delivery unit are configured as a perforated rolling unit and are electrically conductive.

The receiving unit comprises a non-stick coating. In this way, a soiling and adhering of a base binder element 23 to regions not occupied by abrasive elements 11 can be prevented. Optimally, the non-stick coating has an electrical conductivity that is, in particular, low enough so as to discharge incorrectly placed abrasive elements 11 and to allow them to fall back. This can be particularly advantageous for fine abrasive elements 11, in particular.

1.-13. (canceled)

14. An abrasive for a flexible abrasive disc for abrading a workpiece, the abrasive comprising:
a plurality of main abrasive elements; and
an adhesion promoter arranged on the plurality of main abrasive elements.

15. The abrasive according to claim 14, wherein the adhesion promoter is configured as a coating surrounding the plurality of main abrasive elements.

16. The abrasive according to claim 14, further comprising:
a plurality of support elements arranged on the plurality of main abrasive elements and configured to support the plurality of main abrasive elements,
wherein the adhesion promoter surrounds the plurality of main abrasive elements and/or the plurality of support elements,
wherein the adhesion promoter holds the plurality of support elements on the plurality of main abrasive elements,
wherein main abrasive elements of the plurality of main abrasive elements are formed from natural and/or synthetic diamond, and
wherein the adhesion promoter is formed from a bicomponent polyurethane.

17. The abrasive according to claim 16, wherein a first extension of a first main abrasive element of the plurality of main abrasive elements is greater by at least 100% compared to a second extension of a first support element of the plurality of support elements.

18. A flexible abrasive disc for abrading a workpiece, comprising:
a flexible carrier element;
an abrasive including (i) a plurality of main abrasive elements, and (ii) an adhesion promoter arranged on the plurality of main abrasive elements; and
a base binder element and/or a cover binder element configured to bind the abrasive to the flexible carrier element.

19. The flexible abrasive disc according to claim 18, wherein the base binder element and/or the cover binder element is formed from a phenolic resin.

20. The flexible abrasive disc according to claim 18, further comprising:
an adhesion limiting element arranged on the flexible carrier element and configured to limit an assembly of the base binder element on the flexible carrier element.

21. The flexible abrasive disc according to claim 18, wherein:
a through-hole extends through the flexible carrier element,
the through-hole is configured to receive the abrasive during an application of the abrasive onto a first side of the flexible carrier element,
the base binder element is arranged on the through-hole, and
the base binder element is arranged on a second side of the flexible carrier element that is opposite the first side and faces away from the applied abrasive.

22. A method for producing a flexible abrasive disc, comprising:
providing a flexible carrier element for receiving an abrasive;
providing a base binder element for holding the abrasive on the flexible carrier element; and
assembling the abrasive, such that a plurality of main abrasive elements of the abrasive protrude in relation to the base binder element,
wherein the abrasive includes (i) the plurality of main abrasive elements, and (ii) an adhesion promoter arranged on the plurality of main abrasive elements.

23. The method according to claim 22, wherein an orientation of the plurality of main abrasive elements is a function of an abrading plane of the flexible abrasive disc.

24. The method according to claim 22, wherein:
the abrasive is assembled on the flexible carrier element with a first respective end of the plurality of main abrasive elements facing the flexible carrier element and a second respective end of the plurality of main abrasive elements facing away from the flexible carrier element, and
the second end is arranged at a predetermined distance from a side of the flexible carrier element facing away from the abrasive.

25. The method according to claim 22, further comprising:
electrostatically receiving the abrasive with an electrostatic receiver; and
delivering the abrasive with a delivery device onto the base binder element,
wherein the delivery device comprises a protrusion in relation to a side of the flexible carrier element facing the abrasive, and
wherein the protrusion is greater than a thickness of the base binder element.

26. The method according to claim 25, wherein the delivery device and the electrostatic receiver are configured as a perforated roller.

27. The method according to claim 25, wherein the electrostatic receiver comprises a non-stick coating.
